(19) United States
(12) Patent Application Publication
(10) Pub. No.: US 2010/0200206 A1
(43) Pub. Date: Aug. 12, 2010

(54) Heat Sink Assembly

(76) Inventors: Carlo Mandrone, Newburyport, MA (US); Joseph P. Mennucci, Manville, RI (US); Kaveh Azar, N. Quincy, MA (US)

Correspondence Address: Amit K. Singh, 1075 Salem Street, North Andover, MA, 01845-4908, US

(21) Appl. No.: 12/370,311

(22) Filed: Feb. 12, 2009

(51) Int. Cl. F28F 7/00; B23P 11/02; A44B 21/00

(52) U.S. Cl. 165/185; 29/453; 24/457

(57) ABSTRACT

Apparatus and method for making a heat sink assembly. The apparatus includes a first clip configured to be urgingly attached to a heat producing device, the first clip having a first edge, a second edge, a third edge, and a fourth edge. The apparatus further includes a heat sink configured to be attached to the first clip, and a second clip configured to be attached to the first clip, the second clip being sized to accommodate a portion of the heat sink, and the second clip urging the heat sink towards the heat producing device. Methods to make the foregoing apparatus are also described.

### BACKGROUND

1. Field

This disclosure is generally related to heat sinks and in particular to components constituting a heat sink assembly.

2. Description of Related Art

A conventional heat sink device typically utilizes an array of extended surfaces, such as fins, formed on a base and projecting into fluid, typically air, surrounding an electronic device producing heat. The base is placed in thermally close contact with a heat producing device to provide a conduction path to the array of fins. Fluid circulation, through forced or natural convection, around the array of fins, acts as a heat transfer medium to cool the heat producing device to a satisfactory operating temperature.

For a larger heat producing device or a heat producing device operating at a higher temperature, a typical heat sink will need to be larger. This translates into a larger size for a hardware needed to attach the heat sink to the heat producing device. On the other hand, modern circuit boards have an ever-larger number of components installed on a printed circuit board (PCB) thereby reducing available space for an adequately-sized heat sink.

Still further, the hardware needed to attach the heat sink should be designed to secure the heat sink to the heat producing device with adequate pressure at elevated temperatures for an extended period of time.

### BRIEF SUMMARY

Embodiments of the present disclosure provide an apparatus and method for making a heat sink assembly.

Briefly described, in architecture, one embodiment of the apparatus, among others, can be implemented as follows.

An apparatus includes a first clip configured to be urgingly attached to a heat producing device, the first clip having a first edge, a second edge, a third edge, and a fourth edge. The apparatus may further include a heat sink configured to be attached to the first clip, and a second clip configured to be attached to the first clip, the second clip being sized to accommodate a portion of the heat sink, and the second clip urging the heat sink towards the heat producing device.

The present disclosure can also be viewed as providing a method of making a heat sink, the method including providing a first clip to be urgingly attached to a heat producing device, the first clip having a first edge, a second edge, a third edge, and a fourth edge, configuring a heat sink to be attached to the first clip, and configuring a second clip to be attached to the first clip, the second clip being sized to accommodate a portion of the heat sink, and the second clip urging the heat sink towards the heat producing device.

Other apparatuses, methods, features, and advantages of the present invention will be, or will become apparent, to a person having ordinary skill in the art upon examination of the following drawings and detailed description. It is intended that all such additional apparatuses, methods, features, and advantages included within this description, be within the scope of the present disclosure, and be protected by the accompanying claims.

### BRIEF DESCRIPTION OF THE SEVERAL VIEWS OF THE DRAWINGS

Many aspects of the disclosure can be better understood with reference to the following drawings. Components in the drawings are not necessarily to scale, emphasis instead being placed upon clearly illustrating principles of the present invention. Moreover, in the drawing, like-referenced numerals designate corresponding parts throughout the several views.

FIG. 1A is an exploded perspective view of a heat sink assembly in accordance with an exemplary embodiment of the present invention.

FIGS. 1B-1D illustrate several views of the heat sink assembly of FIG. 1A. FIG. 1B illustrates a top plane view of the assembled heat sink assembly of FIG. 1A. FIG. 1C illustrates a side profile view of the assembled heat sink assembly of FIG. 1A at a cross-section line AA. FIG. 1D illustrates a front plane view of the assembled heat sink assembly of FIG. 1A.

FIGS. 2A-2I illustrate several views of a first clip in accordance with an exemplary embodiment of the present invention. FIG. 2A shows a top plane view of the first clip. FIG. 2B shows a cross-section view of the first clip at a cross-section line BB. FIG. 2C illustrates a side profile view of the first clip. FIG. 2D shows a cross-section view of the first clip at a cross-section line AA. FIG. 2E shows detail C of FIG. 2B under an enlargement. FIG. 2F shows another view of the first clip to illustrate a locking tab and raised lettering. FIG. 2G is a perspective view of the first clip showing one of the locking tabs. FIGS. 2H and 2I show details E and F respectively of FIG. 2F.

FIGS. 3A-3C illustrate several views of the second clip in accordance with an exemplary embodiment of the present invention. FIG. 3A is a front plane view of the second clip. FIG. 3B is a top plane view of the second clip before forming into a desired shape. FIG. 3C is a perspective view of the second clip.

FIG. 4 shows an exemplary plot of a size of the first clip versus a mass of the first clip.

FIG. 5 shows a flow-chart of a method of making the heat sink assembly in accordance with an exemplary embodiment of the present invention.

FIGS. 6A-6M, and 6N-6P illustrate several views of a heat sink assembly in accordance with another exemplary embodiment of the present invention. FIGS. 6A-6M, 6N-6P show details of various aspects of the heat sink assembly, another exemplary embodiment of the first clip, and another exemplary embodiment of the second clip.

FIGS. 7A-7M, and 7N-7P illustrate several views of a heat sink assembly in accordance with another exemplary embodiment of the present invention. FIGS. 7A-7M, 7N-7P show details of various aspects of the heat sink assembly, another exemplary embodiment of the first clip, and another exemplary embodiment of the second clip.

FIGS. 8A-8M, and 8N-8P illustrate several views of a heat sink assembly in accordance with another exemplary embodiment of the present invention. FIGS. 8A-8M, 8N-8P show details of various aspects of the heat sink assembly, another exemplary embodiment of the first clip, an exemplary embodiment of a rod, and another exemplary embodiment of the second clip.

FIGS. 9A-9M, and 9N-9P illustrate several views of a heat sink assembly in accordance with another exemplary embodiment of the present invention. FIGS. 9A-9M, 9N-9P show details of various aspects of the heat sink assembly, another exemplary embodiment of the first clip, and another exemplary embodiment of the second clip.

FIGS. 10A-10M, and 10N-10P illustrate several views of a heat sink assembly in accordance with another exemplary embodiment of the present invention. FIGS. 10A-10M, 10N-10P show details of various aspects of the heat sink assembly, another exemplary embodiment of the first clip, and another exemplary embodiment of the second clip.

FIGS. 11A-11M, and 11N-11P illustrate several views of a heat sink assembly in accordance with another exemplary embodiment of the present invention. FIGS. 11A-11M, 11N-11P show details of various aspects of the heat sink assembly, another exemplary embodiment of the first clip, and another exemplary embodiment of the second clip.

FIGS. 12A-12M, and 12N-12P illustrate several views of a heat sink assembly in accordance with another exemplary embodiment of the present invention. FIGS. 12A-12M, 12N-12P show details of various aspects of the heat sink assembly, another exemplary embodiment of the first clip, and another exemplary embodiment of the second clip.

FIGS. 13A-13M, and 13N-13P illustrate several views of a heat sink assembly in accordance with another exemplary embodiment of the present invention. FIGS. 13A-13M, 13N-13P show details of various aspects of the heat sink assembly, another exemplary embodiment of the first clip, and another exemplary embodiment of the second clip.

FIG. 14 shows an exemplary plot of a component size versus a keep out area required for a first clip in excess of a component area. [Include the formula Carlo gave on phone: [(Area of the heat generating device 110+Area of the first clip 220)−Area of the heat generating device 110]/Area of the heat generating device 110.

### DETAILED DESCRIPTION

The present disclosure relates to an apparatus and method for making a heat sink assembly.

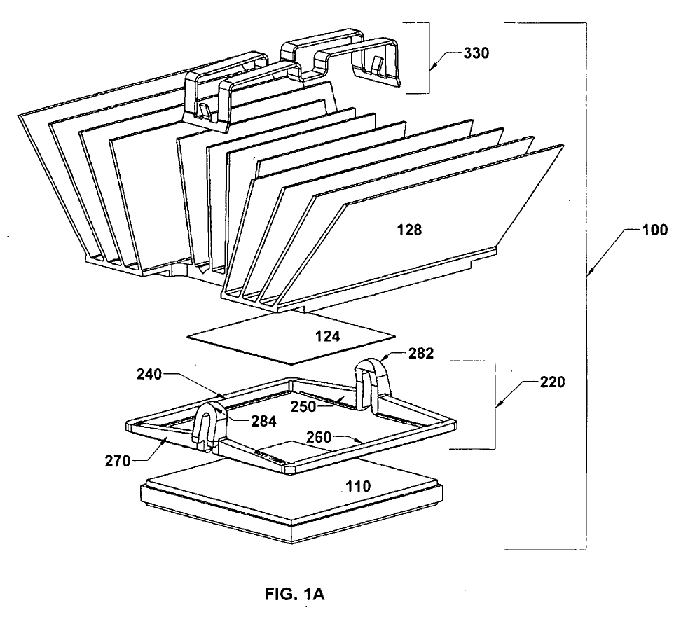

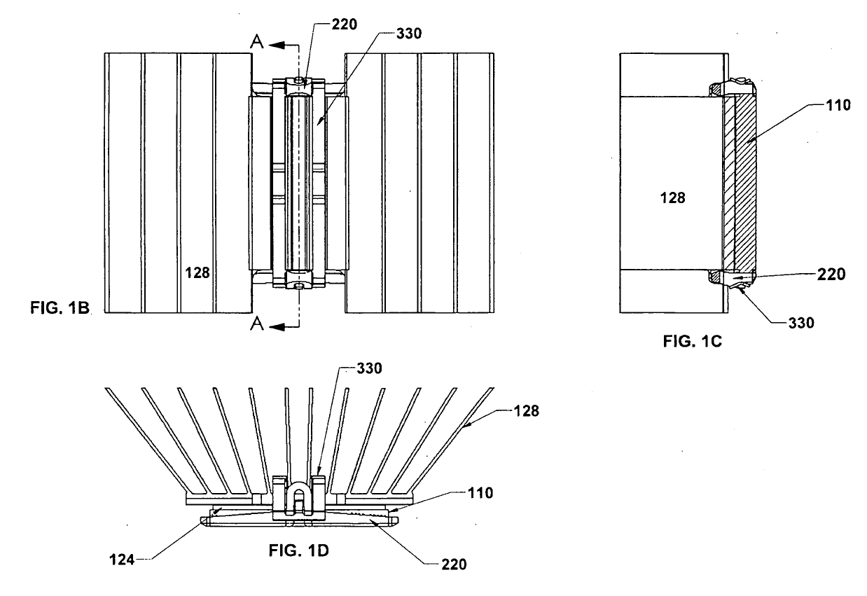

FIG. 1A is a perspective view of a heat sink assembly 100 in accordance with an exemplary embodiment of the present invention. A heat producing device 110 is shown at the bottom the FIG. 1A. A first clip 220 may have at least a first edge 250, a second edge 260, a third edge 270, and a fourth edge 240, as well as hoops 282, 284. In another embodiment of the first clip 220, the first clip 220 may be termed a frame clip 220 configured to be urgingly attached to the heat producing device 110. In a given application, there may be more or fewer hoops than the hoops 282, 284 shown. The heat sink assembly 100 may include a thermal interface material 124, a heat sink 128, and a second clip 330 as shown. The thermal interface material 124 may be one of a phase change material and a thermal interface tape. The thermal interface material 124 may be, for example, paraffin. The heat sink assembly 100 including the first clip 220 and the second clip 330 may exert a force of about 2 lbs. to about 10 lbs. on the heat producing device 110.

In the heat sink assembly 100, the second clip 330 may provide a first force upwards in a direction of the heat sink 128 and a second force in a direction inwards towards the hoops 282, 284. The first force and the second force may each be resolved into vector forces which may exert an inward force along one or more of the first edge 250, the second edge 260, the third edge 270, and the fourth edge 240 of the first clip 220 and the heat producing device 110. The inward force may increase as a separation force increases between the heat sink 128 and the heat producing device 110 when a part of the heat sink assembly 100 may be subjected to shock or vibration. An effect of the separation force may be that the first clip 220 may grip the heat producing device 110 better during shock or vibration helping avoid the heat sink 128 from separating from the heat producing device 110.

Simulation and experimental work has shown that the first clip 220 may apply a clamping force of approximately 4 lbs., in a preferred embodiment of the first clip 220, between the heat sink 128 and the heat producing device 110. The clamping force may drop over time. The clamping force may drop at an elevated temperature.

FIGS. 1B-1D illustrate several views of the heat sink assembly 100 of FIG. 1A. FIG. 1B illustrates a top plane view of the assembled heat sink assembly 100 of FIG. 1A as well as the first clip 220, the second clip 330, the heat sink 128, and the cross-section line AA. FIG. 1C illustrates a side profile view of the assembled heat sink assembly 100 of FIG. 1A at the cross-section line AA thereby showing the heat producing device 110, the first clip 220, the second clip 330, and the heat sink 128. FIG. 1D illustrates a front plane view of the assembled heat sink assembly of FIG. 1A thereby showing the heat producing device 110, the first clip 220, the second clip 330, the thermal interface material 124, and the heat sink 128.

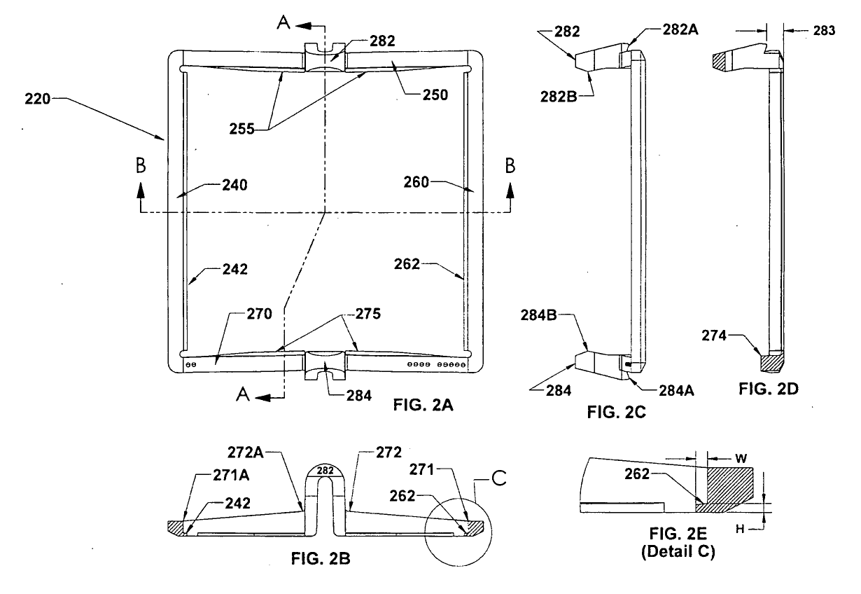

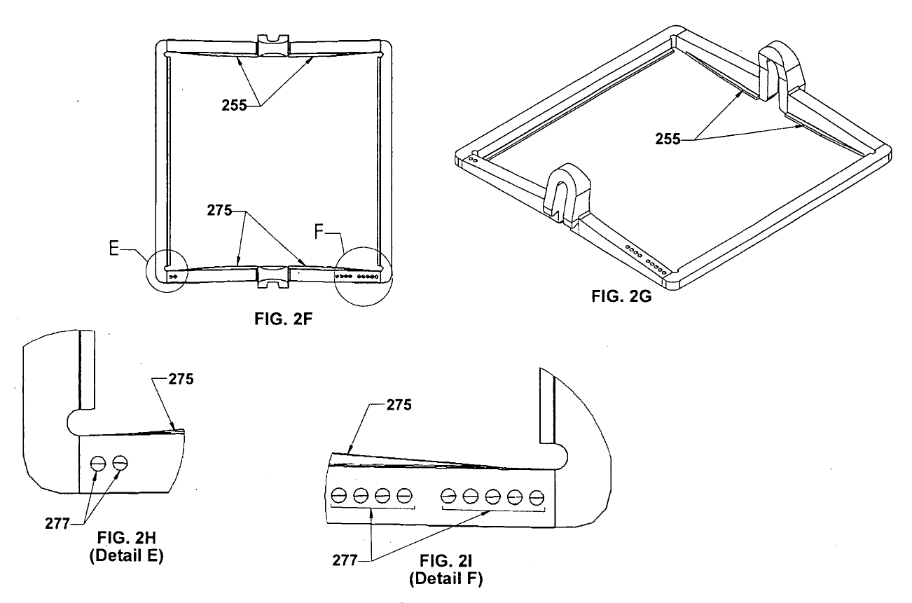

FIGS. 2A-2I illustrate several views of the first clip 220 in accordance with an exemplary embodiment of the present invention. FIG. 2A shows a top plane view of the first clip 220 indicating at least a first edge 250, a second edge 260, a third edge 270, and a fourth edge 240. The first edge 250 may have a hoop 282 and a locking tab 255. The third edge 270 may have a hoop 284 and a locking tab 275. The locking tabs 255, 275 may be of a predetermined shape to attain a desired clamping force. The locking tabs 255, 275 may be formed in a direction of an area enclosed by the first clip 220 as illustrated in FIGS. 1A and 2A. In an embodiment of the first clip 220, both hoops 282 and 284 may be required. In another embodiment of the first clip 220, locking tabs 255 and hoop 282 may be required on the first edge 250, and locking tabs 275 and hoop 284 may be required on the third edge 270. The first clip 220 may be configured at least for one of a stretch and a flexure. The first clip 220 may be capable of undergoing at least one of a stretching and a flexing procedure. FIG. 2B shows a cross-section view of the first clip 220 at a cross-section line BB. FIG. 2C illustrates a side profile view of the first clip 220 showing an overhang 282A and another overhang 284A corresponding to the hoops 282, 284 respectively. FIG. 2C also shows a hoop wedge 282B included in the hoop 282 on a surface facing the hoop 284 and a hoop wedge 284B included in the hoop 284 on a surface facing the hoop 282. Hoop wedges 282B, 284B may provide a mechanical stability to the first clip 220 and the second clip 330 after an installation on the heat sink 128 and the heat producing device 110. Hoop wedges 282B, 284B may further help an installation process and a gripping function of the first clip 220. FIG. 2D shows a cross-section view of the first clip 220 at a cross-section line AA indicating an overhang space 283.

The first edge 250 and the third edge 270 each, shown in FIG. 2A, may have a cross-section 274 more clearly shown in FIG. 2D. The cross-section 274 may increase from a first point 271, 271A (FIG. 2B) proximate to one of the second edge 260 and the fourth edge 240 (FIG. 2A) to a second point 272, 272A (FIG. 2B) proximate to the hoop 284, 282 (FIG. 2A). In other words, hoops 282, 284 are shown in FIG. 2A, and the cross-section 274 of the third edge 270 shown in FIG. 2D may increase in size from the first point 271 near the second edge 260 to the point 272 proximate to the hoop 284. Similarly, the cross-section 274 of the third edge 270 shown in FIG. 2D may increase in size from the first point 271A near the fourth edge 240 to the point 272A proximate to the hoop 284.

FIG. 2B also shows a lock wedge 262. The lock wedge 262 may further help the installation process and the gripping function of the first clip 220.

FIG. 2E shows a detail C of FIG. 2B under an enlargement indicating a height H and a width W of the lock wedge 262. The lock wedge 262 may have a substantially rectangular cross-section. A corresponding lock wedge 242 is shown in FIG. 2B.

FIG. 2F shows another view of the first clip 220 to illustrate locking tabs 255, 275 and raised lettering. FIG. 2G is a perspective view of the first clip 220 showing the locking tab 255. FIGS. 2H and 2I show details E and F respectively of FIG. 2F. FIG. 2H shows raised lettering 277 and a part of the locking tab 275. FIG. 2I shows more of raised lettering 277 and another part of the locking tab 275. The locking tabs 255, 275 may each have a predetermined curvature.

An apparatus of the heat sink assembly 100 may include the first clip 220 configured to be urgingly attached to the heat producing device 110, the first clip 220 having the first edge 250, the second edge 260, the third edge 270, and the fourth edge 240, the heat sink 128 configured to be attached to the first clip 220, and the second clip 330 configured to be attached to the first clip 220, the second clip 330 being sized to accommodate a portion, such as one or more fins, of the heat sink 128, and the second clip 330 urging the heat sink 128 towards the heat producing device 110.

In the heat sink assembly 100, the first clip 220 may have the hoop 282 attached to at least one of the first edge 250 and the third edge 270 of the first clip 220. Another hoop 284 may be attached to the third edge 270.

In the heat sink assembly 100, a portion of the second clip 330 shown in FIG. 1A may be configured to be restrained by the overhang 282A, 284A in the hoop 282, 284 of at least one of the first edge 250 and the third edge 270 respectively and the overhang space 283 of at least one of the first edge 250 and the third edge 270. As a person having ordinary skill in the art would appreciate, a corresponding overhang space for the overhang 284A exists but has not been shown in FIGS. 2C and 2D. The overhang space 283 may have a height in a range of about 1.50 mm to 2.00 mm.

In the heat sink assembly 100, at least one of the second edge 260 and the fourth edge 240 may have a corresponding lock wedge 262, 242 configured to grip the heat producing device 110. The lock wedges 242, 262 may have a typical height H of 0.30 mm and a width W of 0.40 mm as shown in FIG. 2E. In an embodiment of the first clip 220, the lock wedges 242, 262 and the locking tabs 255, 275 may be required for an adequate grip.

In the heat sink assembly 100, the first clip 220 may be configured to be installed in a keep out region having an area ranging from approximately 23.0 mm×22.5 mm for the heat producing device 110 of a nominal size of approximately 17 mm×17 mm to approximately 51.0 mm×50.5 mm for the heat producing device 110 of a nominal size of 45 mm×45 mm as tabulated below in Table 1:

TABLE 1

| | | | Keep out region along |
|---|---|---|---|
| | | Keep out region along | the second edge 260 |
| | Nominal | the first edge 250 or the | or the fourth edge 240 |
| S. No. | size (mm) | third edge 270 (mm) | (mm) |
| 1 | 17.0 | 23.0 | 22.5 |
| 2 | 19.0 | 25.0 | 24.5 |
| 3 | 21.0 | 27.0 | 26.5 |
| 4 | 23.0 | 29.0 | 28.5 |
| 5 | 25.0 | 31.0 | 30.5 |
| 6 | 27.0 | 33.0 | 32.5 |
| 7 | 29.0 | 35.0 | 34.5 |
| 8 | 30.0 | 36.0 | 35.5 |
| 9 | 31.0 | 37.0 | 36.5 |
| 10 | 32.5 | 38.5 | 38.0 |
| 11 | 33.0 | 39.0 | 38.5 |
| 12 | 35.0 | 41.0 | 40.5 |
| 13 | 37.5 | 43.5 | 43.0 |
| 14 | 40.0 | 46.0 | 45.5 |
| 15 | 42.5 | 48.5 | 48.0 |
| 16 | 45.0 | 51.0 | 50.5 |

As examples shown in Table 1, the 23.0 mm×22.5 mm keep out region is for a 17 mm component, and the 51.0 mm×50.5 mm keep out region is for a 45 mm component.

The keep out region, as would be appreciated by a person having ordinary skill in the art, is an area around the heat producing device 110 which permits a room to expand the first clip 220 for installation and removal. In an exemplary embodiment, the keep out region may further include an area of about 1.0 mm×10.0 mm in a vicinity of the hoop 282, 284 on at least one of the first edge 250 and the third edge 270 as shown in FIG. 2A.

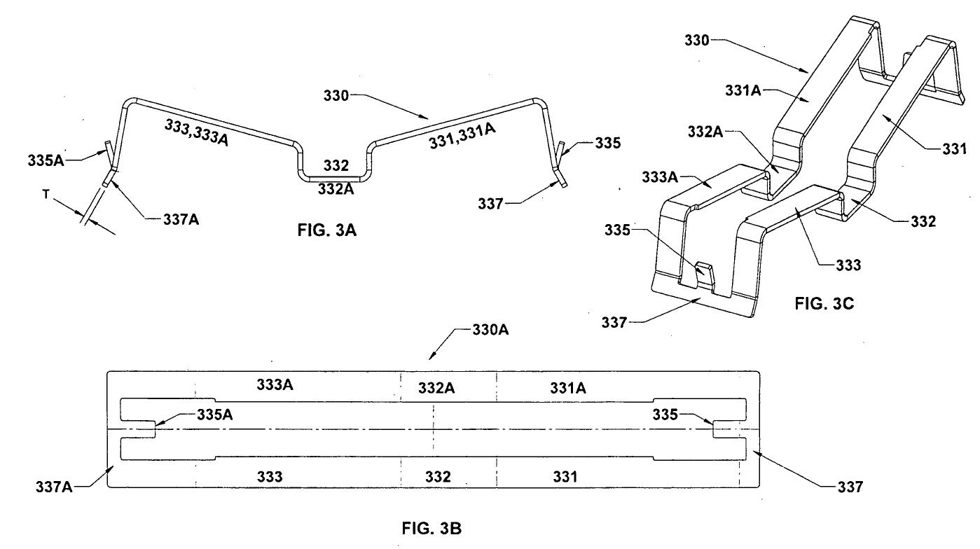

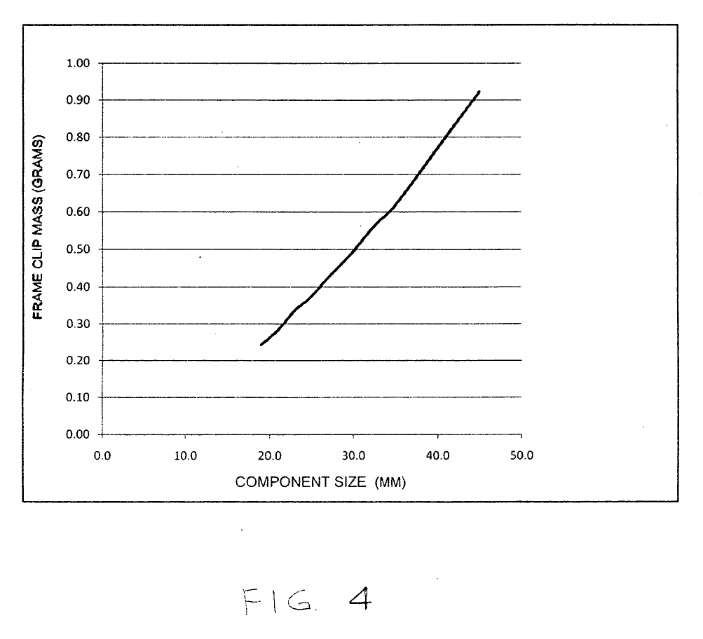

FIGS. 3A-3C illustrate several views of the second clip 330 in accordance with an exemplary embodiment of the present invention. FIG. 3A is a front plane view of the second clip 330. FIG. 3B is a top plane view of the second clip 330 before forming into a desired shape. FIG. 3C is a perspective view of the second clip 330.

The second clip 330, shown in FIGS. 3A and 3C, may include at least one load point 332 configured to urge the heat sink 128 of FIG. 1B towards the heat producing device 110 shown in FIGS. 1A and 1D. There may be additional load points, such as load point 332A, as shown in FIG. 3C, e.g., for exerting more pressure. The load point 332 may include a portion 331 or 333 which is shown spaced apart from the heat sink 128 of FIG. 1B. The load point 332A corresponds to portions 331A, 333A as shown in FIGS. 3B and 3C. The step-like shape of the load point 332 may help control a stiffness of the second clip 330. As shown in FIGS. 3A and 3C in particular, the second clip 330 may include a protrusion 335, 335A configured to removably engage with the hoop 282, 284 of the first clip 220 shown in FIG. 1A.

The second clip 330 may have a thickness T (FIG. 3A) to obtain a predetermined stiffness. An example is to keep the thickness of a sheet the second clip 330 is made from to within ±0.025 mm. Further, edges 337, 337A may rest against the first edge 250 or the third edge 270 or a part of the heat producing device 110 in the heat sink assembly 100. In an embodiment of the second clip 330, the edges 337, 337A may rest against the first edge 250 and the third edge 270 and a part of the heat producing device 110 in the heat sink assembly 100. FIG. 4 shows an exemplary plot of a size of the first clip 220 versus a mass of the first clip 220. An illustrative 29 mm first clip 220 may have about 0.47 grams of the 94V0 plastic known in the art. Similarly, an illustrative 40 mm first clip 220 may have about 0.77 grams of the 94V0 plastic. Other plastics may be from resins such as Solvay Plastics—RADEL™ 5100 and GE Plastics ULTEM™1000. As known in the art, a “29 mm first clip 220” indicates a square first clip 220 having each side equal to 29 mm. Similarly, a “40 mm first clip 220” indicates a square first clip 220 having each side equal to 40 mm.

In addition to meeting the Mil-STD-810 Shock Testing and Unpackaged Drop Testing, the heat sink assembly 100, including the first clip 220 and the second clip 330 meets the Telcordia GR-63-Core Office Vibration standard, the ETSI 300 019 Transportation Vibration standard, the NEBS standards and the RoHS requirements.

Office Vibration in accordance with GR-63-Core includes: sine vibration, 5-100 Hz at 0.1 g, 2 sweeps, 0.1 octave/min. in 3 mutually perpendicular axes. Transportation Vibration in accordance with ETSI EN300 019 includes: random vibration, 5-20 Hz at 1.0 M/s², 20-2000 Hz at −3 dB/octave overall GRMS of 7.83, 30 min./axis in 3 axes.

The heat sink assembly 100, including the first clip 220 and the second clip 330 meets the half sine shock test, in accordance with Mil-STD-810 including: 20 g's at 11 msec ½ sine pulse, 3 shocks/axis, 6 directions, and a total of 18 shocks.

Drop test: the heat sink assembly 100, including the first clip 220 and the second clip 330 meets, includes an unpackaged drop, drop height of 36 inches, and one drop on each of six faces.

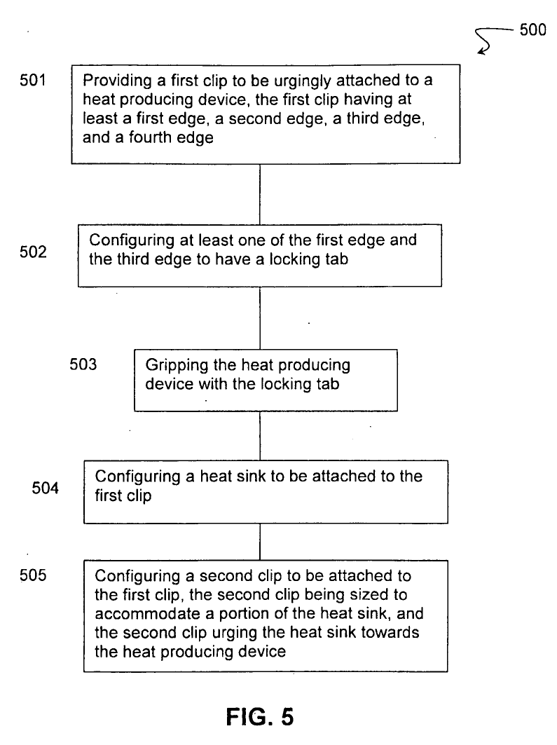

FIG. 5 shows a flow-chart of a method 500 of making the heat sink assembly 100 of FIG. 1A in accordance with an exemplary embodiment of the present disclosure.

The method 500 to make the heat sink assembly 100 shown in FIG. 1A may include providing the first clip 220, as well as other embodiments of the first clip 220 described below, to be urgingly attached to a heat producing device 110, as well as other embodiments of the heat producing device 110 described below, the first clip 220 having at least the first edge 250, the second edge 260, the third edge 270, and the fourth edge 240 (Block 501), configuring at least one of the first edge 250 and the third edge 270 to have a locking tab 255, 275 (Block 502), gripping the heat producing device 110 with the locking tab 255, 275 (Block 503), configuring the heat sink 128 to be attached to the first clip 220, as well as other embodiments of the first clip 220 described below, (Block 504), and configuring a second clip 330, as well as other embodiments of the second clip 330 described below, to be attached to the first clip 220, as well as other embodiments of the first clip 220 described below, the second clip 330 being sized to accommodate a portion of the heat sink 128, and the second clip 330 urging the heat sink 128 towards the heat producing device 110 (Block 505).The method 500 may further include installing the first clip 220, as well as other embodiments of the first clip 220 described below, on the heat producing device 110, as well as other embodiments of the heat producing device 110 described below, attached to a circuit substrate. The circuit substrate may be a PCB (Printed Circuit Board). The installing the first clip 220, as well as other embodiments of the first clip 220 described below, on the heat producing device 110, as well as other embodiments of the heat producing device 110 described below, attached to the circuit substrate may be after soldering the heat producing device, such as after a solder reflow. In the method 500, the providing the first clip 220, as well as other embodiments of the first clip 220 described below, may further include configuring the first clip 220, as well as other embodiments of the first clip 220 described below, at least for one of stretching and flexing the first clip 220, as well as other embodiments of the first clip 220 described below.

In the method 500, the providing the first clip 220 may further include attaching a hoop, such as hoop 282 or hoop 284, to at least one of the first edge 250 and the third edge 270 of the first clip 220.

In the method 500, the gripping the heat producing device 110 may further include curving at least one of the first edge 250 and the third edge 270 in a direction of an area enclosed by the first clip 220.

In the method 500, the providing the first clip 220 may further include dimensioning a cross-section of the at least one of the first edge 250 and the third edge 270, as shown in FIG. 2A, such that the cross-section increases from a first point 271, 271A proximate to one of the second edge 260 and the fourth edge 240 to a second point 272, 272A, as shown in FIG. 2B, proximate to the hoop 282, 284.

In the method 500, the attaching the hoop 282, 284 may further include restraining a portion of the second clip 330, shown in FIGS. 3A and 3C, by the overhang 282A, 284A in the hoop 282, 284 of at least one of the first edge 250 and the third edge 270 and the overhang space 283 of at least one of the first edge 250 and the third edge 270. As described earlier, the overhang space corresponding to the hoop 284 is not shown in FIGS. 2A-2D.

The method 500 may further include configuring the lock wedge 262, shown in FIG. 2E, to grip the heat producing device 110 shown in FIG. 1A.

In the method 500, the configuring the second clip 330 may further be including at least one load point 332 configured to urge the heat sink 128, shown in FIG. 1A, towards the heat producing device 110.

In the method 500, the configuring the second clip 330 may still further include configuring the protrusion 335, 335A, shown in FIG. 3A, to removably engage with the hoop 282, 284 of the first clip 220 shown in FIG. 2A.

The method 500 may further include disposing the thermal interface material 124 between the heat sink 128 and the heat producing device 110 as shown in FIG. 1A. In the method 500, the configuring the second clip 330 may further include selecting a thickness to obtain a predetermined stiffness.

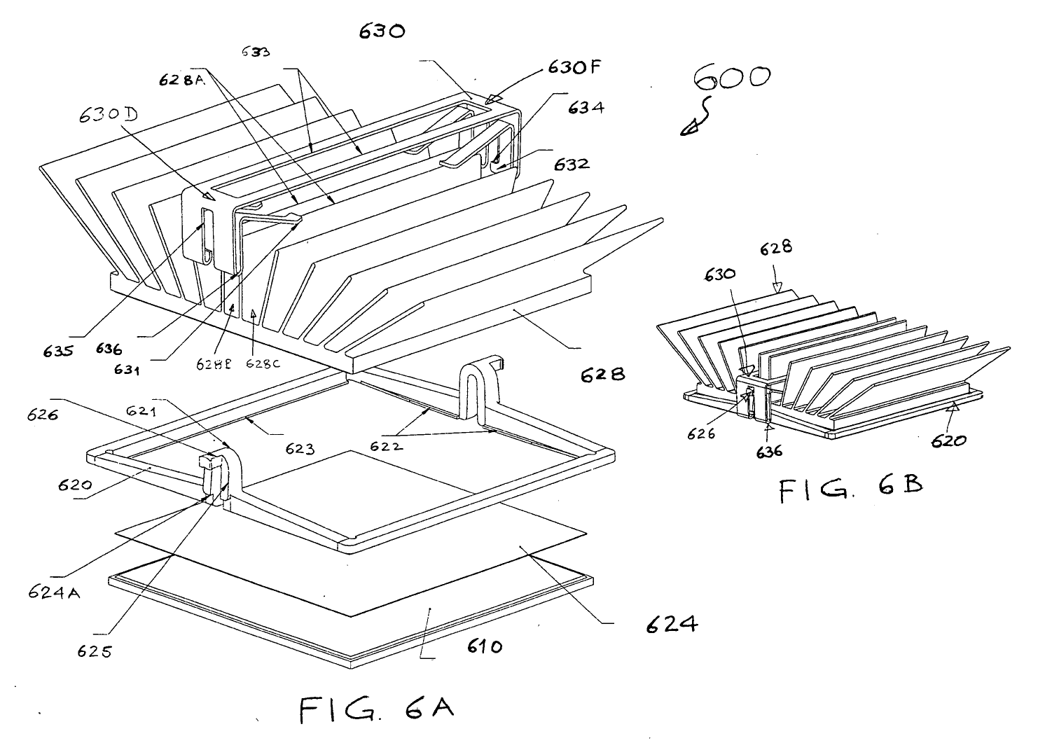

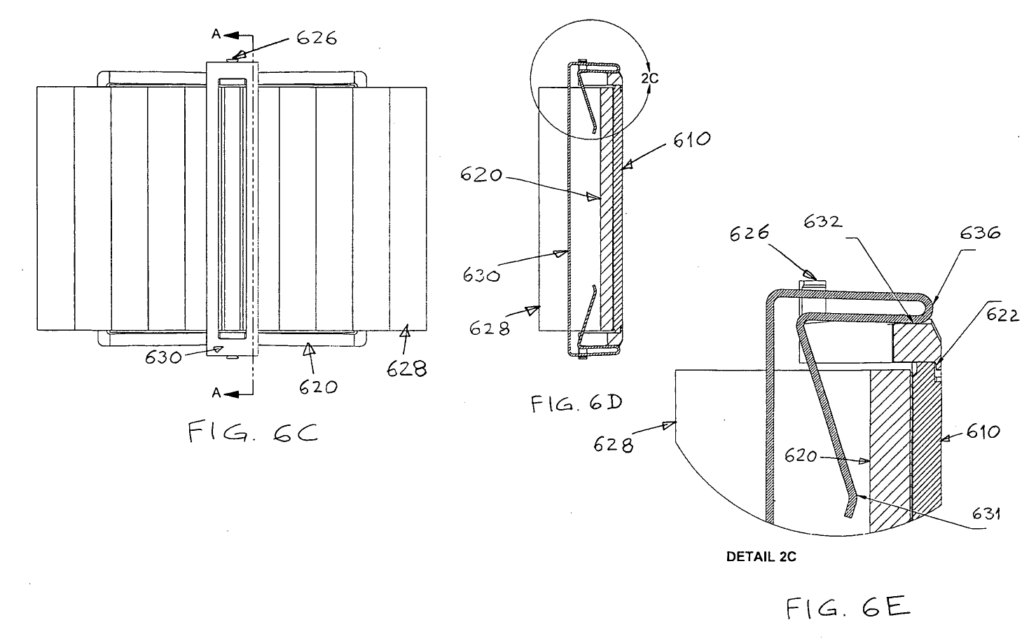

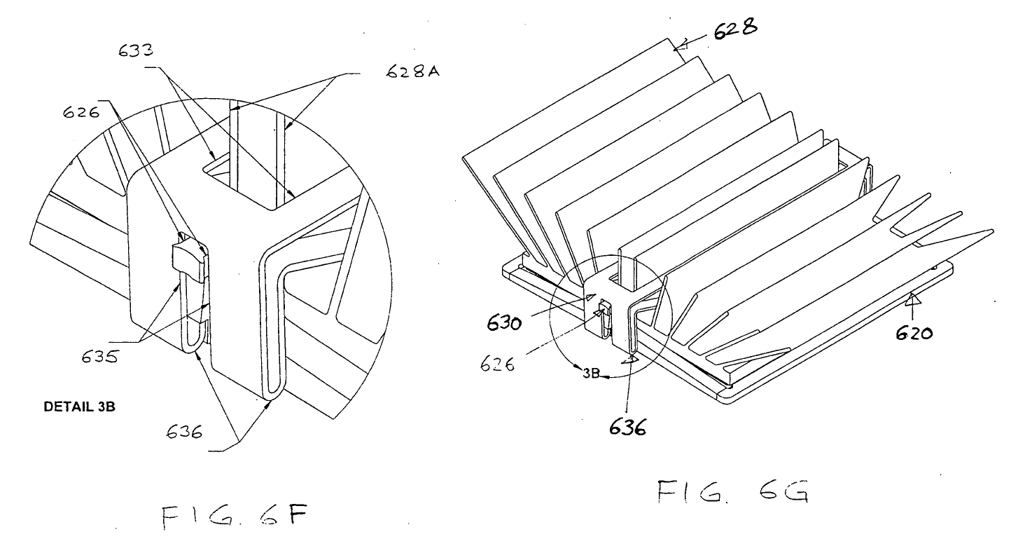

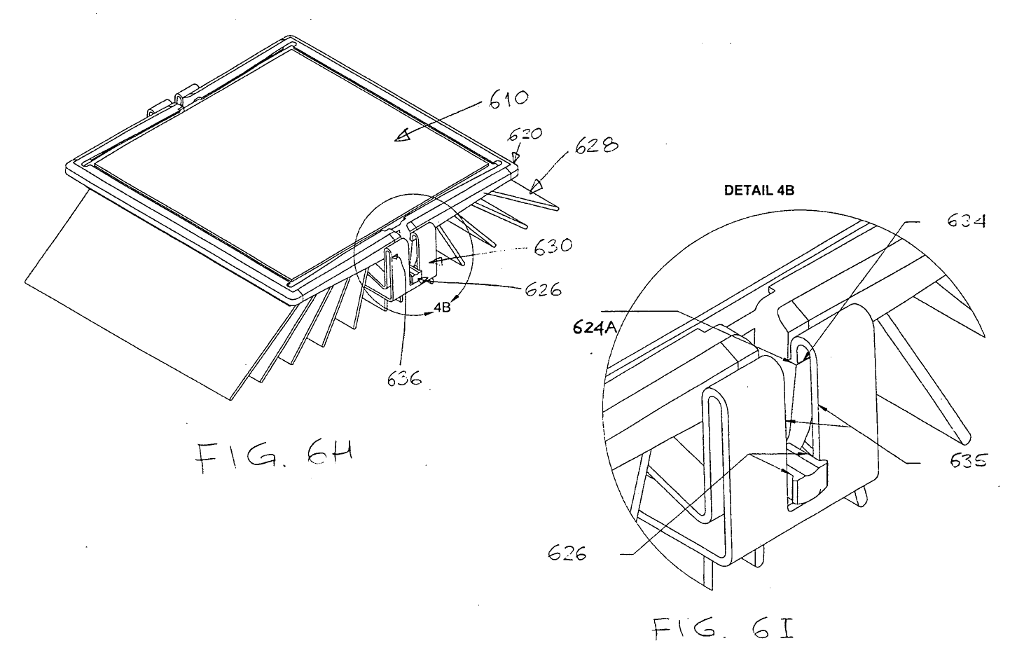

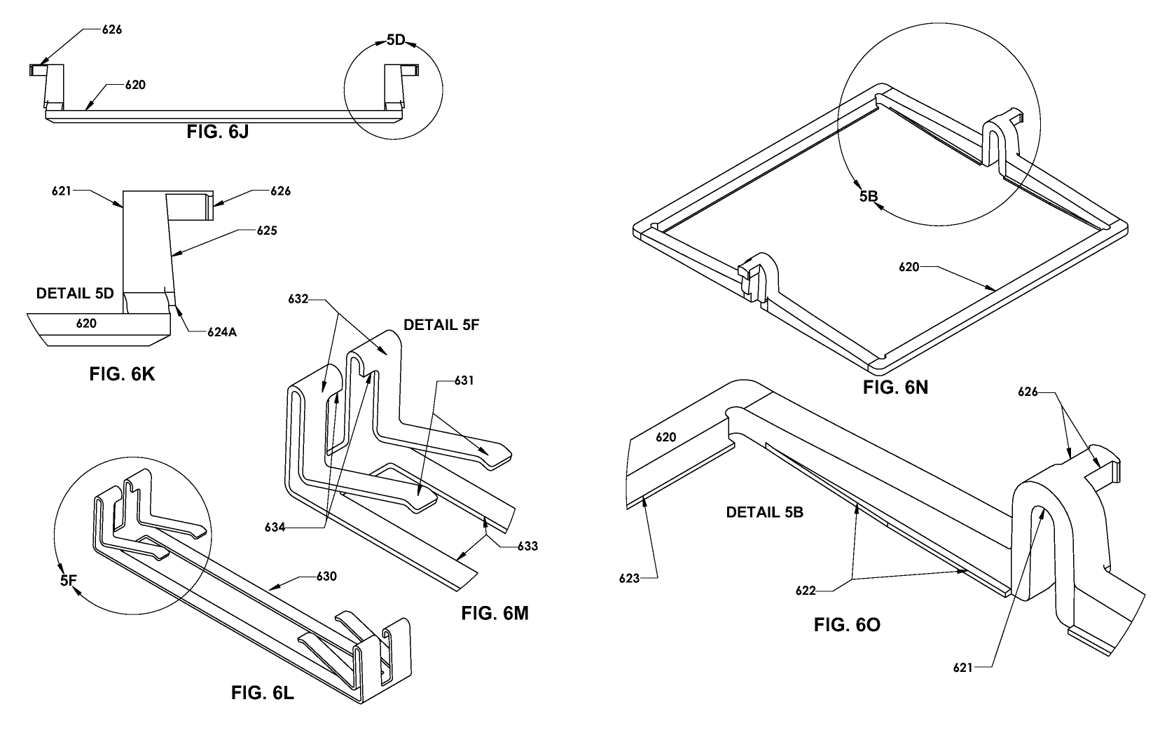

FIGS. 6A-6M, and 6N-6P illustrate several views of a heat sink assembly in accordance with another exemplary embodiment of the present invention. FIGS. 6A-6M, 6N-6P show details of various aspects of the heat sink assembly, another exemplary embodiment of the first clip, and another exemplary embodiment of the second clip.

In an exploded perspective view in FIG. 6A, various features of a heat sink assembly 600 as another embodiment of the present disclosure, are shown as discussed below. FIG. 6B shows an assembled perspective view of the heat sink assembly 600.

A first clip 620 may be a part assembled to the heat producing device 610. The first clip 620 may provide assembly features or locking features for a second clip 630. The first clip 620 may be fabricated from a thermoplastic. The first clip 620 may be designed to have a positive engagement to heat producing device 610 along four sides, such as the at least the first edge 250, the second edge 260, the third edge 270, and the fourth edge 240 shown in FIG. 1A. The first clip 620 may be easily scaled to accommodate the heat producing device 610 that may range from 17 mm to 45 mm in size.

A hoop 621, included in the first clip 620, may allow the first clip 620 to be placed on the heat producing device 610 without an aid of a special tool. The hoop 621 may aid an assembly of the first clip 620 to the heat producing device 610 without undergoing a substantial plastic deformation. The hoop 621 may provide a horizontal locking between first clip 620 and the heat sink 628. A first clip ramp 625, included in the hoop 621 may aid in an easy installation of the second clip 630 without a need for one or more special assembly tools. A locking tab 622 may provide a vertical locking between the first clip 620 and the heat producing device 610. A tapered design, as more clearly shown in FIG. 6P, may help an assembly of the first clip 620 to the heat producing device 610 without the aid of one or more special tools. A lock wedge 623 may provide a vertical locking between the first clip 620 and the heat producing device 610. Accordingly, the first clip 620 may be configured to be included in the heat sink assembly 600 by a human body. A first clip 620 to second clip 630 vertical lock feature 624A may provide a vertical locking between the first clip 620 and the second clip 630. A shaft 626 may provide a horizontal locking between the first clip 620 and the second clip 630.

The second clip 630 may apply a vertical clamping between the heat sink 628 and the heat producing device 610. The Second clip 630 may apply a horizontal clamping between the first clip 620 and the heat producing device 610. The second clip 630 may be fabricated from stainless steel. The second clip 630 may be easily scaled to accommodate the heat producing device 610 that may range from about 17 mm through about 45 mm in size. A profile geometry of the second clip 630 may allow a large elastic deflection capable to accommodate a heat producing device 610 height ranging from about 1.5 mm through about 4.0 mm. The Second clip 630 may reduce an air flow blockage in the heat sink 628 fin channels 628B, 628C shown in FIG. 6A.

A second clip vertical clamping feature 631 may provide a vertical clamping load between the heat sink 628 and the heat producing device 610. The second clip vertical clamping feature 631 may insure that a low thermal impedance is maintained at an interface between the heat sink 628, a thermal interface material 624, and the heat producing device 610. There are four load points, owing to each of the second clip vertical clamping feature 631, in the heat sink assembly 600. The four load points may insure a substantially uniform clamping load over the surfaces contacting the thermal interface material 624.

A second clip 630 to heat producing device 610 horizontal clamping feature 632 may provide a horizontal clamping load between the second clip 630, the first clip 610 and the heat producing device 610. The second clip 630 to heat producing device 610 horizontal clamping feature 632 may insure a long term stability of the heat sink assembly 600. There are four load points, owing to each of the first clip vertical clamping feature 632, in the heat sink assembly 600. The four load points per heat sink assembly 600 may insure an added stability of the heat sink assembly 600.

A second clip 630 to heat sink 628 lock feature 633 may provide a horizontal locking between the second clip 630 and the heat sink 628. The second clip 630 to heat sink 628 lock feature 633 may aid in stabilizing the heat sink 628 during shock and vibration loads. A second clip 630 to first clip 620 vertical lock feature 634 may provide a vertical locking between the first clip 620 and the second clip 630. A second clip 630 to first clip 620 horizontal lock feature 635 may provide a horizontal locking between the first clip 620 and the second clip 630. A second clip hoop 636 may increase a length of the second clip 630 profile and an elastic deflection capacity of the second clip 630.

A heat sink 628 may help cool the heat producing device 610. A heat sink 628 to second clip 630 horizontal lock feature 628A may provide a horizontal locking between the heat sink 628 and the second clip 630. A thermal interface material 624 may help a removal of heat from a heat producing device 610. The heat producing device 610 may require heat removal. The heat producing device 610 may have a Ball Grid Array type interconnect for attaching the first clip 620.

FIG. 6C shows a top plane view of the assembled heat sink assembly 600 shown in FIG. 6B. The first clip 620, the shaft 626, the second clip 630, and the heat sink 628 may be seen in FIG. 6C. FIG. 6D illustrates a side profile view of the assembled heat sink assembly 600 of FIG. 6B at the cross-section line AA thereby showing the heat producing device 610, the first clip 620, the second clip 630, and the heat sink 628. A Detail 2C from FIG. 6D is illustrated more clearly in FIG. 6E, thereby illustrating the heat producing device 610, the first clip 620, the locking tab 622, the shaft 626, the second clip vertical clamping feature 631, the second clip 630 to heat producing device 610 horizontal clamping feature 632, and the second clip hoop 636.

FIG. 6F shows a Detail 3B of FIG. 6G where FIG. 6G illustrates another perspective view, featuring the first clip 620, the shaft 626, the heat sink 628, the second clip 630, and the second clip hoop 636, of the assembled heat sink assembly 600 shown in FIG. 6B. FIG. 6F shows the shaft 626, the heat sink 628 to second clip 630 horizontal lock feature 628A, the second clip 630 to heat sink 628 lock feature 633, the second clip 630 to first clip 620 horizontal lock feature 635, and the second clip hoop 636.

FIG. 6H shows another perspective view of the assembled heat sink assembly 600 featuring the heat producing device 610, the first clip 620, the shaft 626, the heat sink 628, the second clip 630, and the second clip hoop 636. FIG. 6I shows a Detail 4B of FIG. 6H, thereby illustrating the first clip 620 to second clip 630 vertical lock feature 624A, the shaft 626, the second clip 630 to first clip 620 vertical lock feature 634, and the second clip 630 to first clip 620 horizontal lock feature 635.

FIG. 6J shows a side profile view of the first clip 620 including the shaft 626. A Detail 5D of FIG. 6J is shown in FIG. 6K illustrating the first clip 620, the hoop 621, the first clip 620 to second clip 630 vertical lock feature 624A, the first clip ramp 625, and the shaft 626. FIG. 6L shows a perspective view of the second clip 630. FIG. 6M shows a Detail 5F of FIG. 6L, thereby illustrating the second clip vertical clamping feature 631, the second clip 630 to heat producing device 610 horizontal clamping feature 632, the second clip 630 to heat sink 628 lock feature 633, and the second clip 630 to first clip 620 vertical lock feature 634. FIG. 6N shows a perspective view of the first clip 620. FIG. 6P shows a Detail 5B of FIG. 6N, thereby illustrating the first clip 620, the hoop 621, the locking tab 622, lock wedge 623, and the shaft 626.

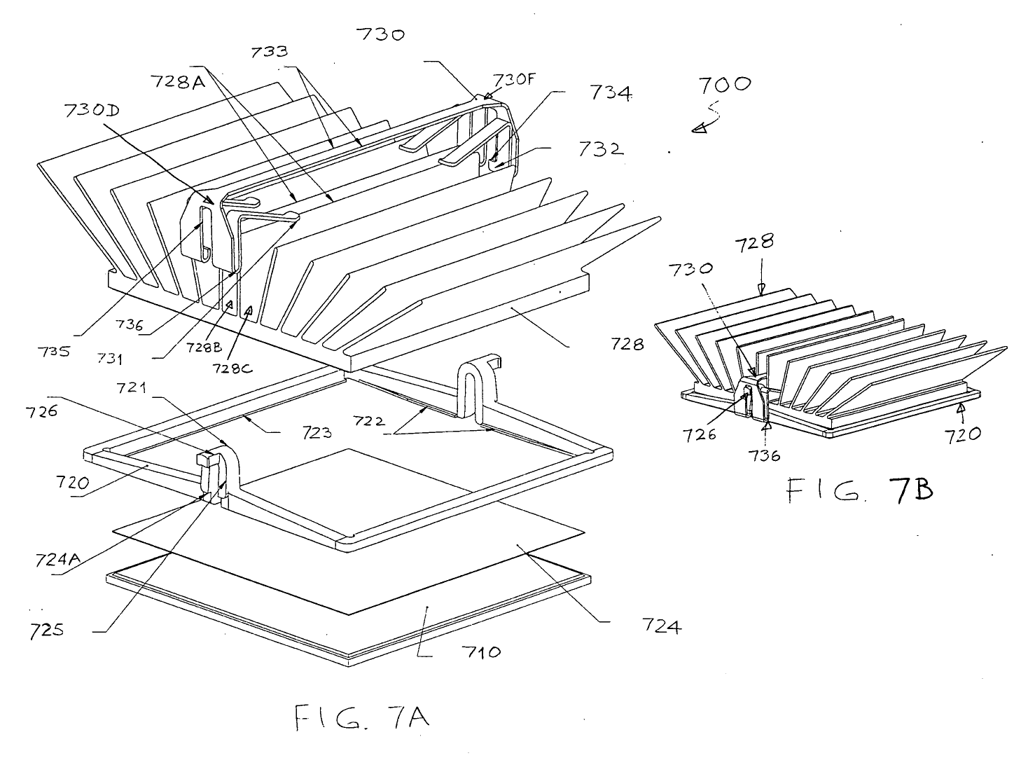

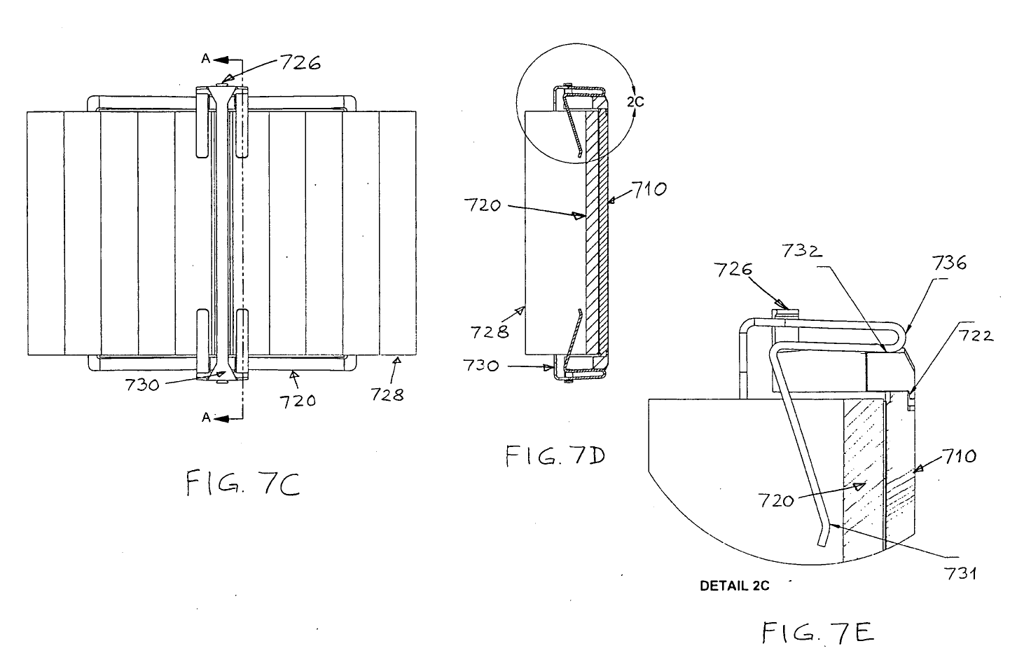

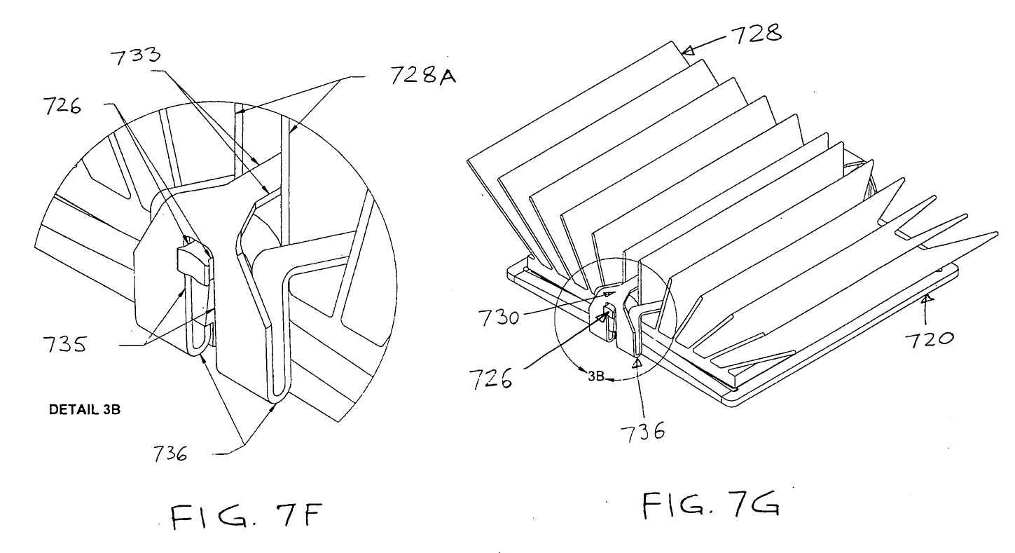

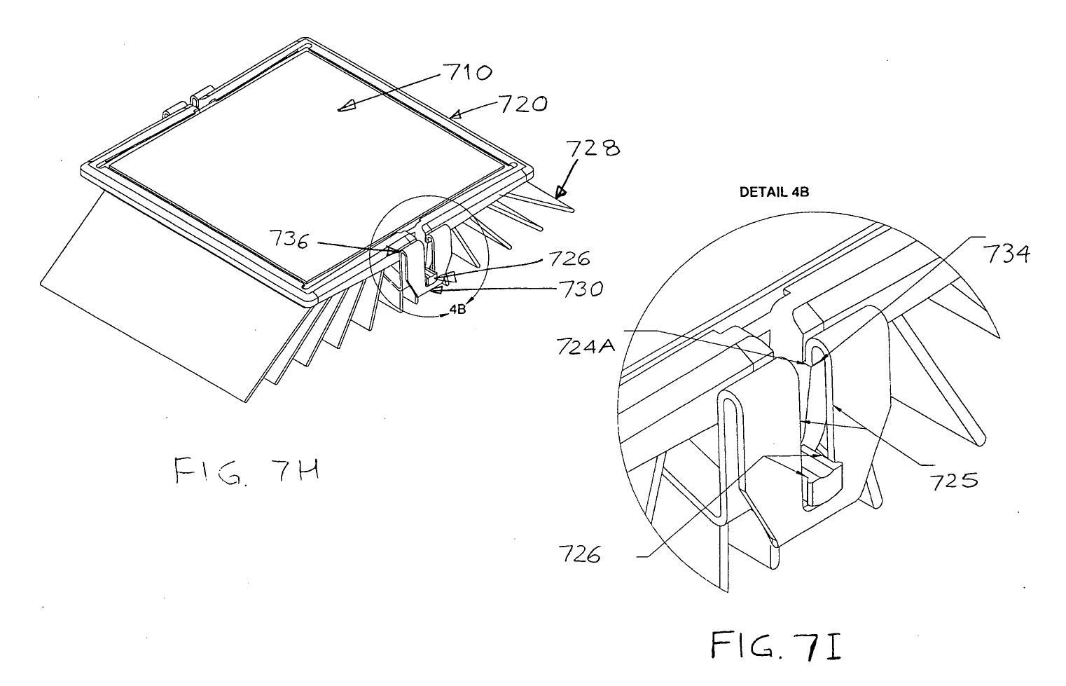

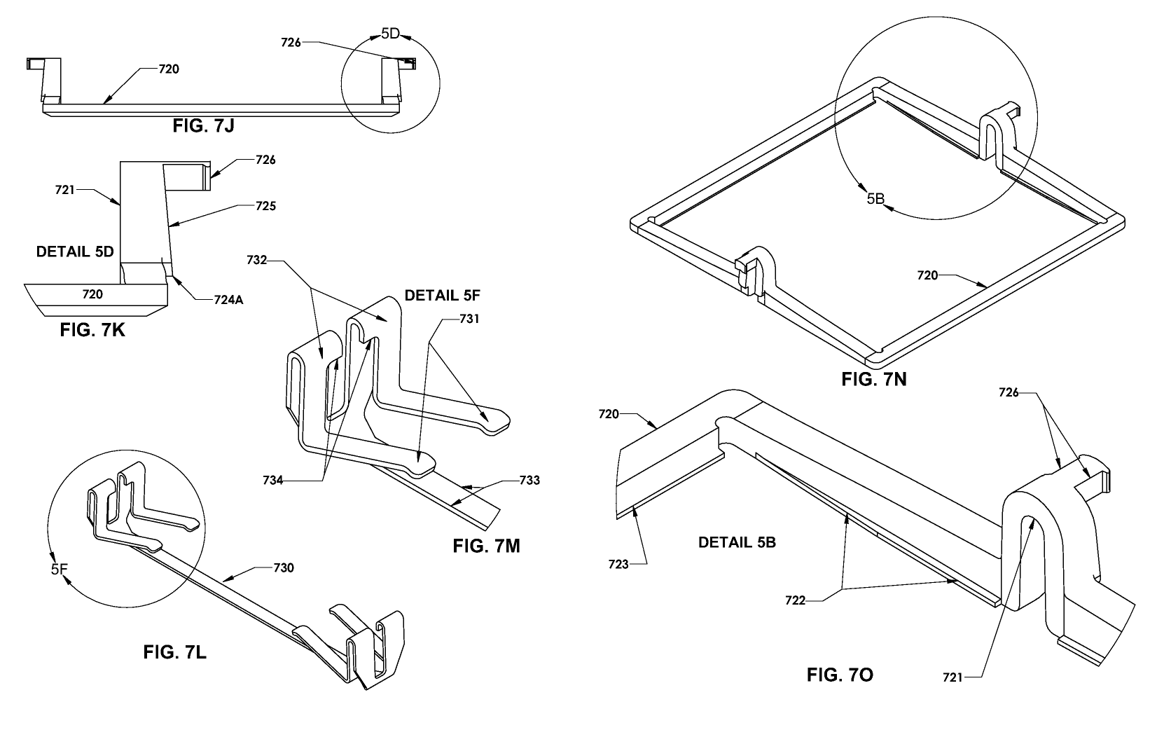

FIGS. 7A-7M, and 7N-7P illustrate several views of a heat sink assembly in accordance with another exemplary embodiment of the present invention. FIGS. 7A-7M, 7N-7P show details of various aspects of the heat sink assembly, another exemplary embodiment of the first clip, and another exemplary embodiment of the second clip.

In an exploded perspective view in FIG. 7A, various features of a heat sink assembly 700 as another embodiment of the present disclosure, are shown as discussed below. FIG. 7B shows an assembled perspective view of the heat sink assembly 700.

A first clip 720 may be a part assembled to the heat producing device 710. The first clip 720 may provide assembly features or locking features for a second clip 730. The first clip 720 may be fabricated from a thermoplastic. The first clip 720 may be designed to have a positive engagement to heat producing device 710 along four sides, such as the at least the first edge 250, the second edge 260, the third edge 270, and the fourth edge 240 shown in FIG. 1A. The first clip 720 may be easily scaled to accommodate the heat producing device 710 that may range from 17 mm to 45 mm in size.

A hoop 721, included in the first clip 720, may allow the first clip 720 to be placed on the heat producing device 710 without an aid of a special tool. The hoop 721 may aid an assembly of the first clip 720 to the heat producing device 710 without undergoing a substantial plastic deformation. The hoop 721 may provide a horizontal locking between first clip 720 and the heat sink 728. A first clip ramp 725, included in the hoop 721 may aid in an easy installation of the second clip 730 without a need for one or more special assembly tools. A locking tab 722 may provide a vertical locking between the first clip 720 and the heat producing device 710. A tapered design, as more clearly shown in FIG. 7P, may help an assembly of the first clip 720 to the heat producing device 710 without the aid of one or more special tools. A lock wedge 723 may provide a vertical locking between the first clip 720 and the heat producing device 710. Accordingly, the first clip 720 may be configured to be included in the heat sink assembly 700 by a human body. A first clip 720 to second clip 730 vertical lock feature 724A may provide a vertical locking between the first clip 720 and the second clip 730. A shaft 626 may provide a horizontal locking between the first clip 720 and the second clip 730.

The second clip 730 may apply a vertical clamping between the heat sink 728 and the heat producing device 710. The Second clip 730 may apply a horizontal clamping between the first clip 720 and the heat producing device 710. The second clip 730 may be fabricated from stainless steel. The second clip 730 may be easily scaled to accommodate the heat producing device 710 that may range from about 17 mm through about 45 mm in size. A profile geometry of the second clip 730 may allow a large elastic deflection capable to accommodate a heat producing device 710 height ranging from about 1.5 mm through about 4.0 mm. The Second clip 730 may reduce an air flow blockage in the heat sink 728 fin channels 728B, 728C shown in FIG. 7A.

A second clip vertical clamping feature 731 may provide a vertical clamping load between the heat sink 728 and the heat producing device 710. The second clip vertical clamping feature 731 may insure that a low thermal impedance is maintained at an interface between the heat sink 728, a thermal interface material 724, and the heat producing device 710. There are four load points, owing to each of the second clip vertical clamping feature 731, in the heat sink assembly 700. The four load points may insure a substantially uniform clamping load over the surfaces contacting the thermal interface material 724.

A second clip 730 to heat producing device 710 horizontal clamping feature 732 may provide a horizontal clamping load between the second clip 730, the first clip 710 and the heat producing device 710. The second clip 730 to heat producing device 710 horizontal clamping feature 732 may insure a long term stability of the heat sink assembly 700. There are four load points, owing to each of the first clip vertical clamping feature 732, in the heat sink assembly 700. The four load points per heat sink assembly 700 may insure an added stability of the heat sink assembly 700.

A second clip 730 to heat sink 728 lock feature 733 may provide a horizontal locking between the second clip 730 and the heat sink 728. The second clip 730 to heat sink 728 lock feature 733 may aid in stabilizing the heat sink 728 during shock and vibration loads. A second clip 730 to first clip 720 vertical lock feature 734 may provide a vertical locking between the first clip 720 and the second clip 730. A second clip 730 to first clip 720 horizontal lock feature 735 may provide a horizontal locking between the first clip 720 and the second clip 730. A second clip hoop 736 may increase a length of the second clip 730 profile and an elastic deflection capacity of the second clip 730.

A heat sink 728 may help cool the heat producing device 710. A heat sink 728 to second clip 730 horizontal lock feature 728A may provide a horizontal locking between the heat sink 728 and the second clip 730. A thermal interface material 724 may help a removal of heat from a heat producing device 710. The heat producing device 710 may require heat removal. The heat producing device 710 may have a Ball Grid Array type interconnect for attaching the first clip 720.

FIG. 7C shows a top plane view of the assembled heat sink assembly 700 shown in FIG. 7B. The first clip 720, the shaft 726, the second clip 730, and the heat sink 728 may be seen in FIG. 7C. FIG. 7D illustrates a side profile view of the assembled heat sink assembly 700 of FIG. 7B at the cross-section line AA thereby showing the heat producing device 710, the first clip 720, the second clip 730, and the heat sink 728. A Detail 2C from FIG. 7D is illustrated more clearly in FIG. 7E, thereby illustrating the shaft 726, the second clip 730 to heat producing device 710 horizontal clamping feature 732, the second clip hoop 736, the locking tab 722, the heat producing device 710, the first clip 720, and the second clip vertical clamping feature 731.

FIG. 7F shows a Detail 3B of FIG. 7G where FIG. 7G illustrates another perspective view, featuring the first clip 720, the shaft 726, the heat sink 728, the second clip 730, and the second clip hoop 736, of the assembled heat sink assembly 700 shown in FIG. 7B. FIG. 7F shows the second clip 730 to heat sink 728 lock feature 733, the shaft 726, the heat sink 728 to second clip 730 horizontal lock feature 728A, the second clip 730 to first clip 720 horizontal lock feature 735, and the second clip hoop 736.

FIG. 7H shows another perspective view of the assembled heat sink assembly 700 featuring the heat producing device 710, the first clip 720, the shaft 726, the heat sink 728, the second clip 730, and the second clip hoop 736. FIG. 7I shows a Detail 4B of FIG. 7H, thereby illustrating the first clip 720 to second clip 730 vertical lock feature 724A, the shaft 726, the second clip 730 to first clip 720 vertical lock feature 734, and the second clip 730 to first clip 720 horizontal lock feature 735.

FIG. 7J shows a side profile view of the first clip 720 including the shaft 726. A Detail 5D of FIG. 7J is shown in FIG. 7K illustrating the first clip 720, the hoop 721, the first clip 720 to second clip 730 vertical lock feature 724A, the first clip ramp 725, and the shaft 726. FIG. 7L shows a perspective view of the second clip 730. FIG. 7M shows a Detail 5F of FIG. 7L, thereby illustrating the second clip vertical clamping feature 731, the second clip 730 to heat producing device 710 horizontal clamping feature 732, the second clip 730 to heat sink 728 lock feature 733, and the second clip 730 to first clip 720 vertical lock feature 734. FIG. 7N shows a perspective view of the first clip 720. FIG. 7P shows a Detail 5B of FIG. 7N, thereby illustrating the first clip 720, the hoop 721, the locking tab 722, lock wedge 723, and the shaft 726.

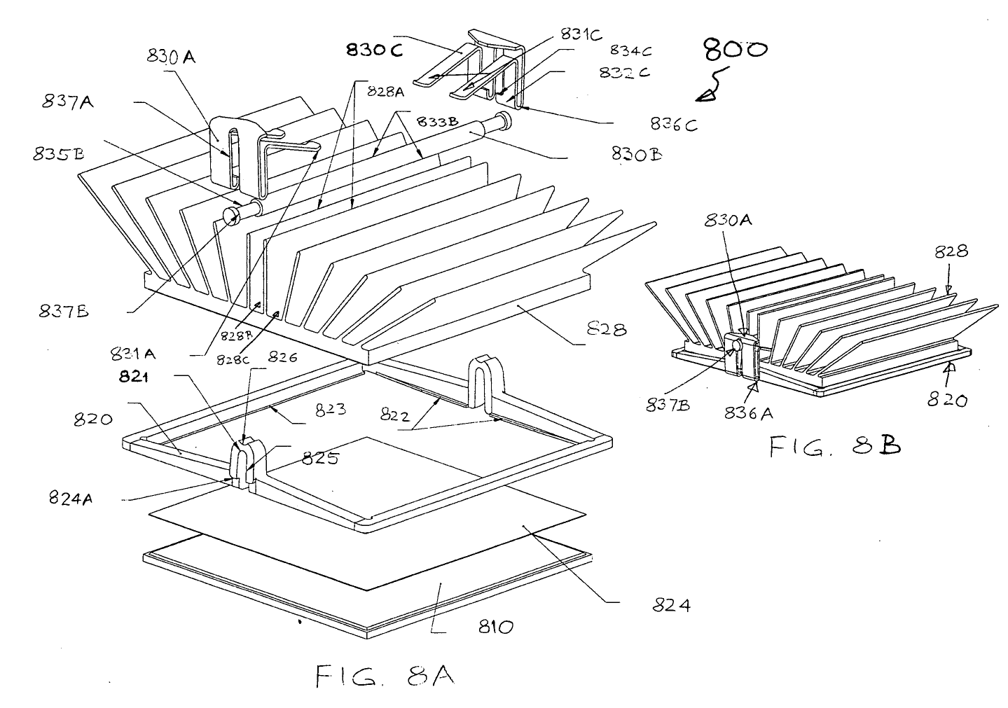

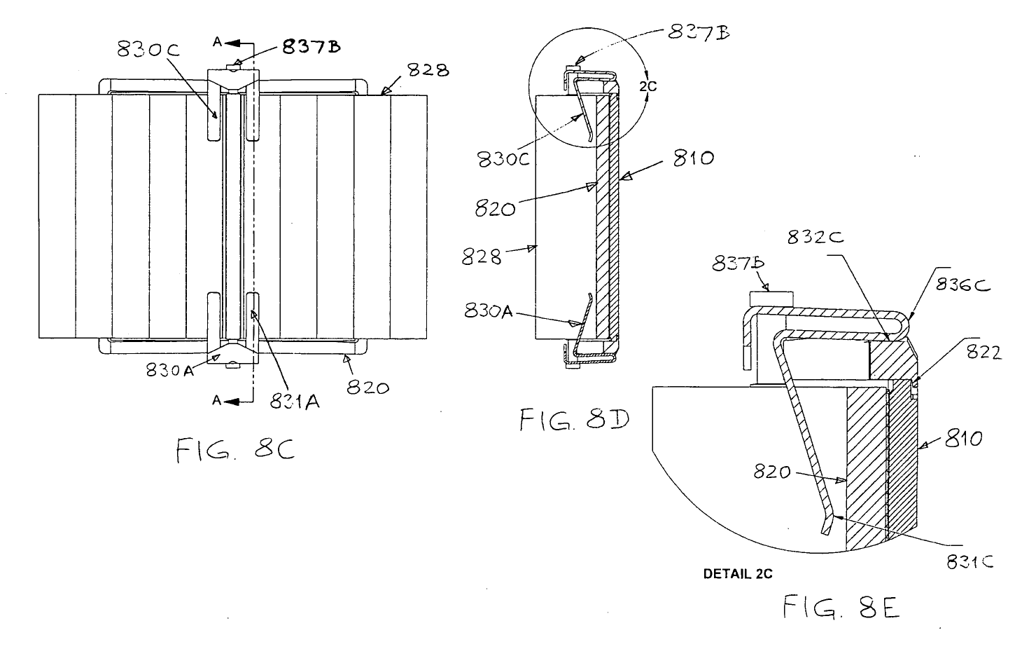

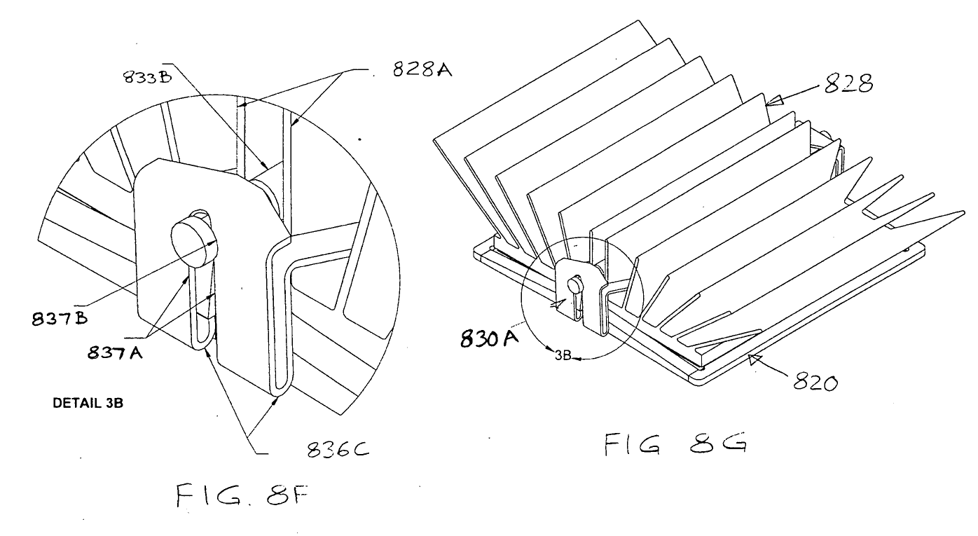

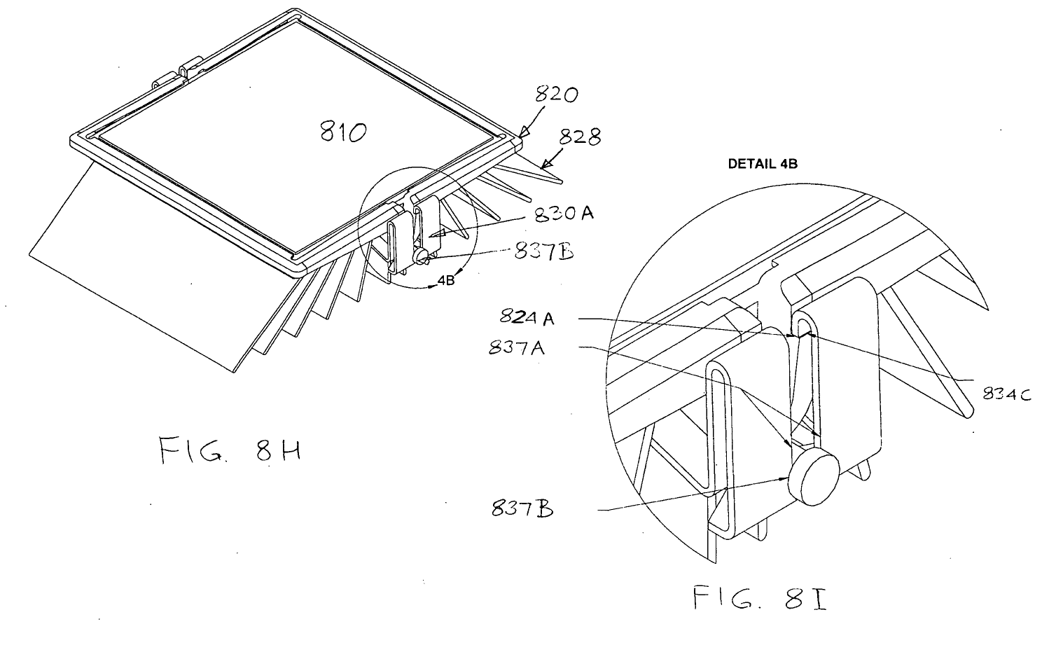

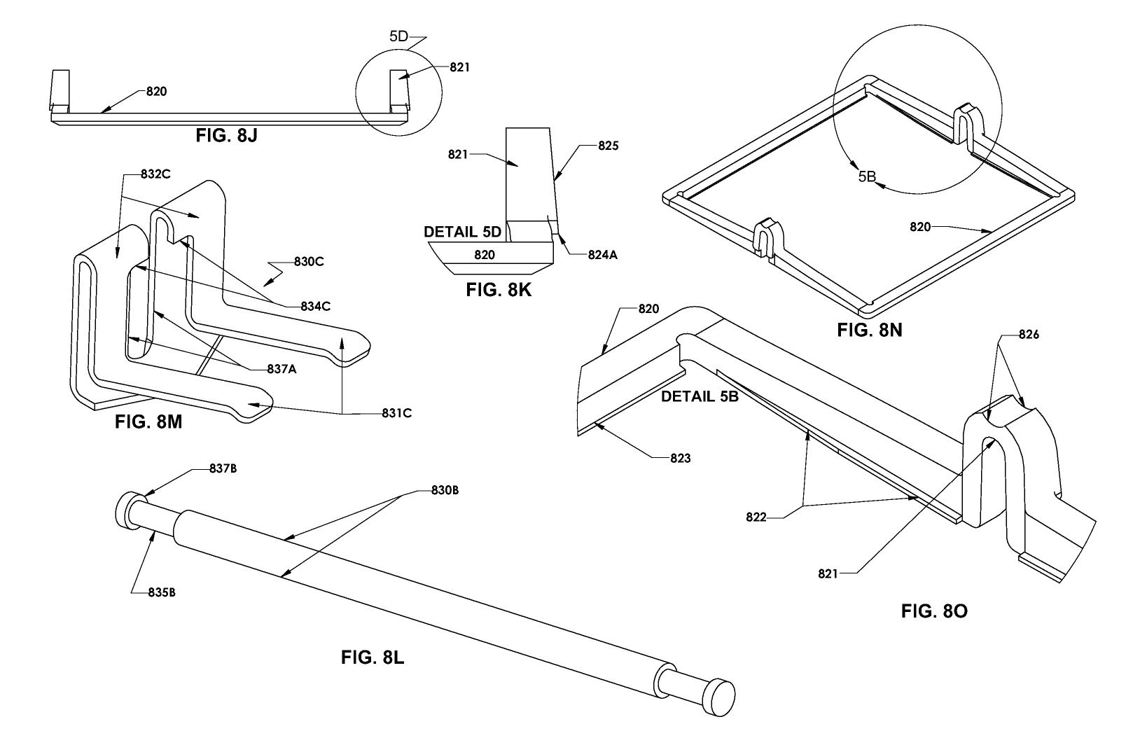

FIGS. 8A-8M, and 8N-8P illustrate several views of a heat sink assembly in accordance with another exemplary embodiment of the present invention. FIGS. 8A-8M, 8N-8P show details of various aspects of the heat sink assembly, another exemplary embodiment of the first clip, an exemplary embodiment of a rod, and another exemplary embodiment of the second clip.

In an exploded perspective view in FIG. 8A, various features of a heat sink assembly 800 as another embodiment of the present disclosure, are shown as discussed below. FIG. 8B shows an assembled perspective view of the heat sink assembly 800.

A first clip 820 may be a part assembled to the heat producing device 810. The first clip 820 may provide assembly features or locking features for second clips 830A, 830C. The first clip 820 may be fabricated from a thermoplastic. The first clip 820 may be designed to have a positive engagement to heat producing device 810 along four sides, such as the at least the first edge 250, the second edge 260, the third edge 270, and the fourth edge 240 shown in FIG. 1A. The first clip 820 may be easily scaled to accommodate the heat producing device 810 that may range from 17 mm to 45 mm in size.

Hoop 821, included in the first clip 820, may allow the first clip 820 to be placed on the heat producing device 810 without an aid of a special tool. The hoop 821 may aid an assembly of the first clip 820 to the heat producing device 810 without undergoing a substantial plastic deformation. The hoop 821 may provide a horizontal locking between first clip 820 and the heat sink 828. A first clip ramp 825, included in the hoop 821 may aid in an easy installation of the second clips 830A, 830C without a need for one or more special assembly tools. A locking tab 822 may provide a vertical locking between the first clip 820 and the heat producing device 810. A tapered design, as more clearly shown in FIG. 8P, may help an assembly of the first clip 820 to the heat producing device 810 without the aid of one or more special tools. A lock wedge 823 may provide a vertical locking between the first clip 820 and the heat producing device 810. Accordingly, the first clip 820 may be configured to be included in the heat sink assembly 800 by a human body. A first clip 820 to second clips 830A, 830C vertical lock feature 824A may provide a vertical locking between the first clip 820 and the second clips 830A, 830C. A notch 826, such as a concave notch, may provide a horizontal locking between the first clip 820 and the second clips 830A, 830C.

Second clips 830A, 830C may apply a vertical clamping between the heat sink 828 and the heat producing device 810. The second clips 830A, 830C may apply a horizontal clamping between the first clip 820 and the heat producing device 810. The second clips 830A, 830C may be fabricated from stainless steel. The second clips 830A, 830C may be common to a range of sizes of the heat producing device 810. A profile geometry of the second clips 830A, 830C may allow a large elastic deflection capable to accommodate a height of the heat producing device 810 ranging from about 1.5 mm to about 4.0 mm.

A rod 830B may be easily scaled to accommodate the heat producing device 810 ranging from about 17 mm to about 45 mm in size. The rod 830B may be fabricated from stainless steel. The rod 830B may facilitate a reduced air flow blockage in the heat sink 828 fin channels 828B, 828C shown in FIG. 8A.

A second clip 830A to heat sink 828 vertical clamping feature 831A is included in the second clip 830A. As a person having ordinary skill in the art would appreciate, the second clip 830C may have a similar feature as shown in FIG. 8A. The second clip 830A to heat sink 828 vertical clamping feature 831A may provide a vertical clamping load between the heat sink 828 and the heat producing device 810. The second clip 830A to heat sink 828 vertical clamping feature 831A may insure a low thermal impedance maintained at an interface between the heat sink 828, a thermal interface material 824, and the heat producing device 810. There are four load points, owing to each of the second clip 830A to heat sink 828 vertical clamping feature 831A, in the heat sink assembly 800. The four load points may insure a substantially uniform clamping load over the surfaces contacting the thermal interface material 824.

A second clip 830C to heat producing device 810 horizontal clamping feature 832C is included in the second clip 830C. As a person having ordinary skill in the art would appreciate, the second clip 830A may have a similar feature as shown in FIG. 8A. The second clip 830C to heat producing device 810 horizontal clamping feature 832C may provide a horizontal clamping load between the second clips 830A, 830C, the first clip 820, and the heat producing device 810. The second clip 830C to heat producing device 810 horizontal clamping feature 832C may insure a long term stability of the heat sink assembly 800. There are four load points, owing to each of the second clip 830C to heat producing device 810 horizontal clamping feature 832C, per second clips 830A, 830C for an added stability.

A second clip 830A, 830C to heat producing device 810 horizontal lock feature 833B may provide a horizontal locking between the rod 830B and the heat sink 828. The second clip 830A, 830C to heat producing device 810 horizontal lock feature 833B may aid in stabilizing the heat sink 828 during shock and vibration loads.

A second clip 830A, 830C to first clip 820 vertical lock feature 834C may provide a vertical locking between the first clip 820 and the second clip 830A, 830C. A rod 830B to first clip 820 horizontal lock feature 835B may provide a horizontal locking between the rod 830B and the first clip 820.

A second clip 830C hoop 836C may increase a length of the second clip 830C profile and an elastic deflection capacity of the second clip 830C. As a person having ordinary skill in the art would appreciate, the second clip 830A may have a similar feature as shown in FIG. 8A.

A second clip 830A to rod 830B horizontal lock feature 837A may provide a horizontal locking between the second clip 830A and the rod 830B. As a person having ordinary skill in the art would appreciate, the second clip 830C may have a similar feature as shown in FIG. 8A.

A rod 830B to second clip 830A, 830C horizontal lock feature 837B may provide a horizontal locking between the rod 830B and the second clip 830A. As a person having ordinary skill in the art would appreciate, an end of the rod 830B, proximate to second clip 830C may have a feature similar to the feature 837B as shown in FIG. 8A.

A heat sink 828 may help cool the heat producing device 810. A heat sink 828 to second clip 830A, 830C horizontal lock feature 828A may provide a horizontal locking between the heat sink 828 and the second clip 830A, 830C.

A heat producing device 810 may require heat removal. A thermal interface material 824 may help a removal of heat from the heat producing device 810. The heat producing device 810 may have a Ball Grid Array type interconnect for attaching the first clip 820.

FIG. 8C shows a top plane view of the assembled heat sink assembly 800 shown in FIG. 8B. The first clip 820, the heat sink 828, the second clip 830A, 830C, the second clip 830A to heat sink 828 vertical clamping feature 831A, and the rod 830B to second clip 830A, 830C horizontal lock feature 837B may be seen in FIG. 8C. FIG. 8D illustrates a side profile view of the assembled heat sink assembly 800 of FIG. 8B at the cross-section line AA thereby showing the heat producing device 810, the first clip 820, the second clips 830A, 830C, the heat sink 628, and the rod 830B to second clip 830A, 830C horizontal lock feature 837B. A Detail 2C from FIG. 8D is illustrated more clearly in FIG. 8E, thereby illustrating the heat producing device 810, the first clip 820, the locking tab 822, a second clip 830C to heat sink 828 vertical clamping feature 831C, the second clip 830C to heat producing device 810 horizontal clamping feature 832C, the second clip 830C hoop 836C, and the rod 830B to second clip 830A, 830C horizontal lock feature 837B.

FIG. 8F shows a Detail 3B of FIG. 8G where FIG. 8G illustrates another perspective view, featuring the first clip 820, the heat sink 828, and the second clip 830A, of the assembled heat sink assembly 800 shown in FIG. 8B. FIG. 8F shows the heat sink 828 to second clip 830A, 830C horizontal lock feature 828A, the second clip 830A, 830C to heat producing device 810 horizontal lock feature 833B, the second clip 830C hoop 836C, the second clip 830A to rod 830B horizontal lock feature 837A, and the rod 830B to second clip 830A, 830C horizontal lock feature 837B.

FIG. 8H shows another perspective view of the assembled heat sink assembly 800 featuring the heat producing device 810, the first clip 820, the heat sink 828, the second clip 830A, and the rod 830B to second clip 830A, 830C horizontal lock feature 837B. FIG. 8I shows a Detail 4B of FIG. 8H, thereby illustrating the first clip 820 to second clips 830A, 830C vertical lock feature 824A, the second clip 830A, 830C to first clip 820 vertical lock feature 834C, the second clip 830A to rod 830B horizontal lock feature 837A, and the rod 830B to second clip 830A, 830C horizontal lock feature 837B. It may be noted her that a corresponding area in the second clip 830A is not shown clearly and that the second clip 830A to rod 830B horizontal lock feature 837A is from the second clip 830A.

FIG. 8J shows a side profile view of the first clip 820 including the hoop 821. A Detail 5D of FIG. 8J is shown in FIG. 8K illustrating the first clip 820, the hoop 821, first clip 820 to second clips 830A, 830C vertical lock feature 824A, and the first clip ramp 825. FIG. 8L shows a perspective view of the rod 830B, including the rod 830B to first clip 820 horizontal lock feature 835B, and the rod 830B to second clip 830A, 830C horizontal lock feature 837B. FIG. 8M shows a perspective view of the second clip 830C, thereby illustrating the second clip 830C to heat producing device 810 horizontal clamping feature 832C, second clip 830C to heat sink 828 vertical clamping feature 831C, the second clip 830A, 830C to first clip 820 vertical lock feature 834C, and the second clip 830A to rod 830B horizontal lock feature 837A. Though parts of the second clip 830C are shown here, the second clip 830A to rod 830B horizontal lock feature 837A is shown for the sake of clarity.

FIG. 8N shows a perspective view of the first clip 820. FIG. 8P shows a Detail 5B of FIG. 8N, thereby illustrating the first clip 820, the hoop 821, the locking tab 822, lock wedge 823, and the notch 826.

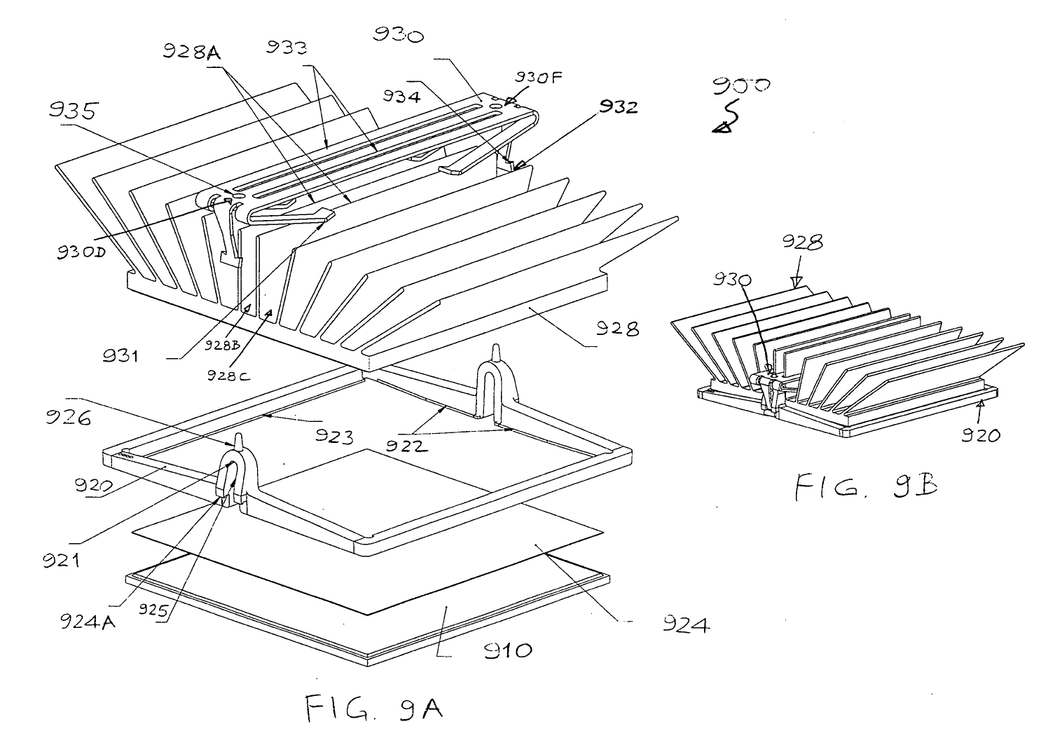

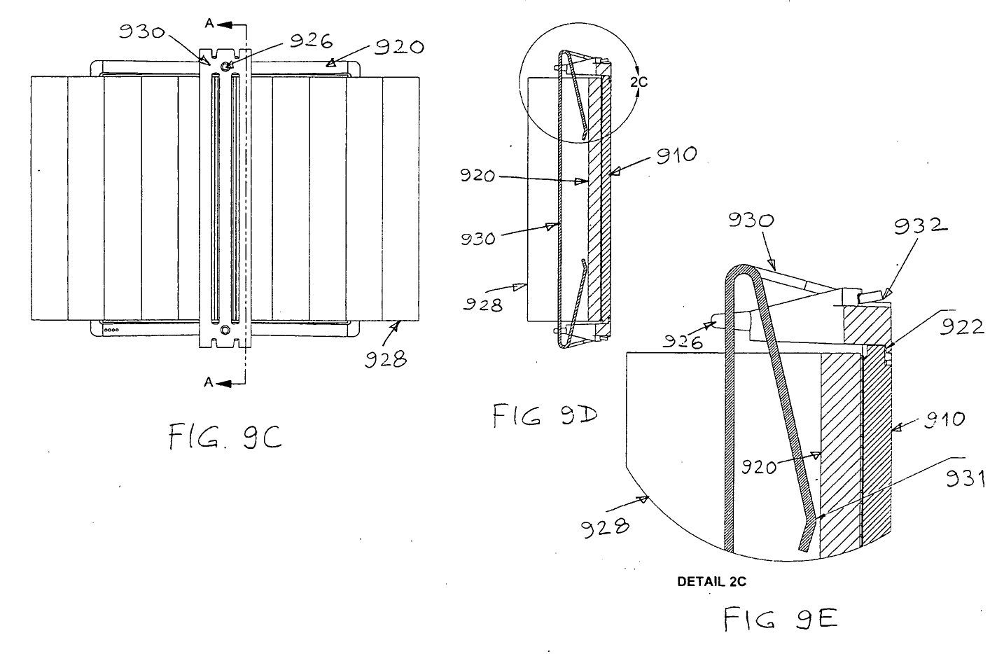

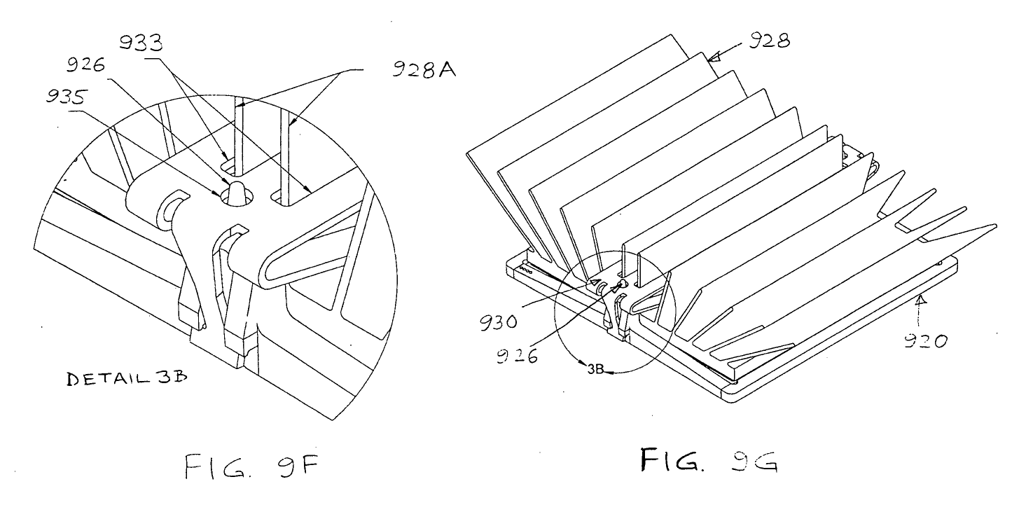

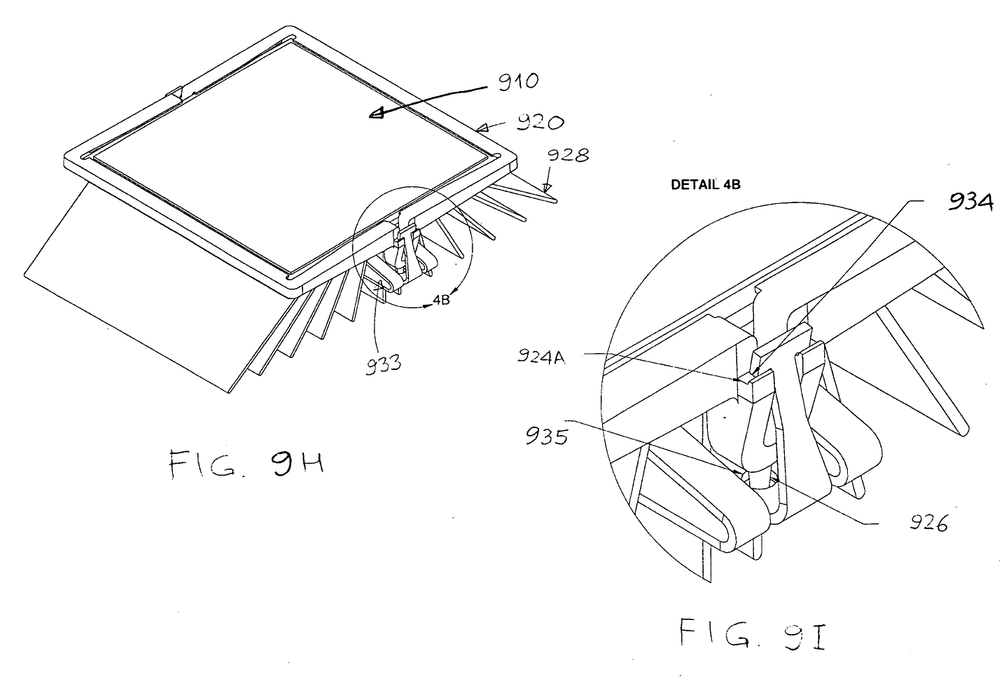

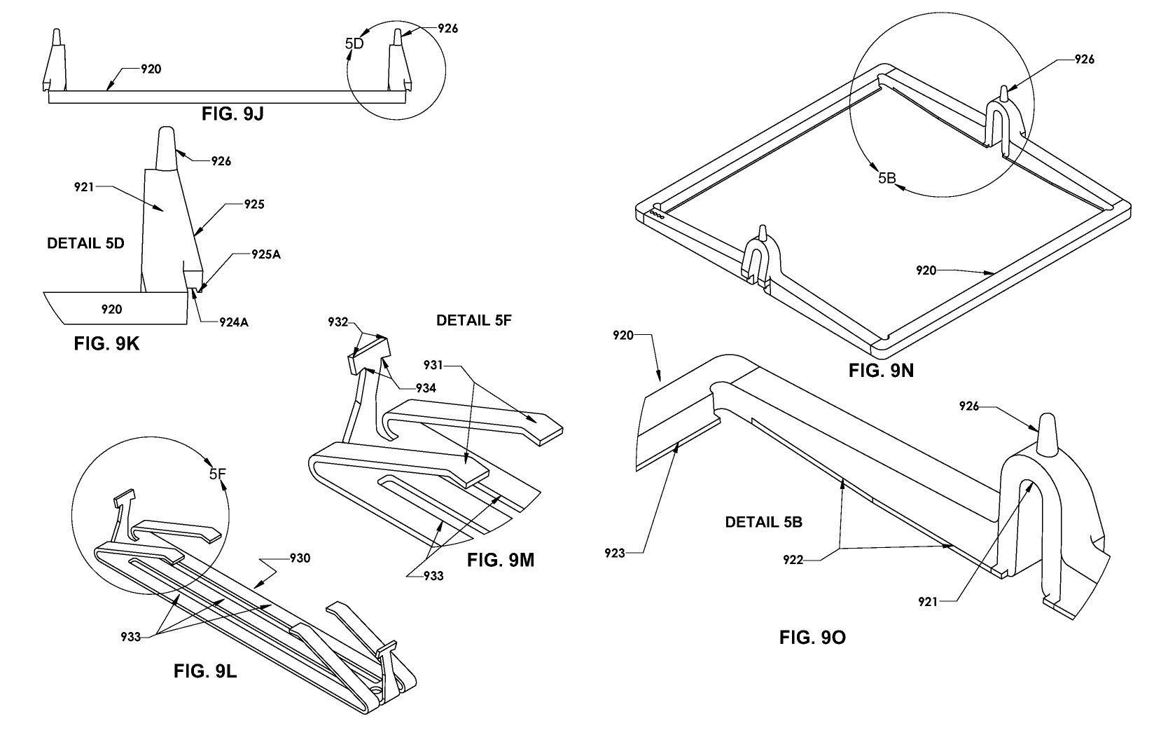

FIGS. 9A-9M, and 9N-9P illustrate several views of a heat sink assembly in accordance with another exemplary embodiment of the present invention. FIGS. 9A-9M, 9N-9P show details of various aspects of the heat sink assembly, another exemplary embodiment of the first clip, and another exemplary embodiment of the second clip. FIG. 9K shows the hoop ramp 925 which may include a positive stop 925A.

In an exploded perspective view in FIG. 9A, various features of a heat sink assembly 900 as another embodiment of the present disclosure, are shown as discussed below. FIG. 9B shows an assembled perspective view of the heat sink assembly 900.

A first clip 920 may be a part assembled to the heat producing device 910. The first clip 920 may provide assembly features or locking features for a second clip 930. The first clip 920 may be fabricated from a thermoplastic. The first clip 920 may be designed to have a positive engagement to heat producing device 910 along four sides, such as the at least the first edge 250, the second edge 260, the third edge 270, and the fourth edge 240 shown in FIG. 1A. The first clip 920 may be easily scaled to accommodate the heat producing device 910 that may range from 17 mm to 45 mm in size.

A hoop 921, included in the first clip 920, may allow the first clip 920 to be placed on the heat producing device 910 without an aid of a special tool. The hoop 921 may aid an assembly of the first clip 920 to the heat producing device 910 without undergoing a substantial plastic deformation. The hoop 921 may provide a horizontal locking between first clip 920 and the heat sink 928. A first clip ramp 925, included in the hoop 921 may aid in an easy installation of the second clip 930 without a need for one or more special assembly tools. A locking tab 922 may provide a vertical locking between the first clip 920 and the heat producing device 910. A tapered design, as more clearly shown in FIG. 9P, may help an assembly of the first clip 920 to the heat producing device 910 without the aid of one or more special tools. A lock wedge 923 may provide a vertical locking between the first clip 920 and the heat producing device 910. Accordingly, the first clip 920 may be configured to be included in the heat sink assembly 900 by a human body. A first clip 920 to second clip 930 vertical lock feature 924A may provide a vertical locking between the first clip 920 and the second clip 930. A pin 926, such as a blunt cone, may provide a horizontal locking between the first clip 920 and the second clip 930.

The second clip 930 may apply a vertical clamping between the heat sink 928 and the heat producing device 910. The Second clip 930 may apply a horizontal clamping between the first clip 920 and the heat producing device 910. The second clip 930 may be fabricated from stainless steel. The second clip 930 may be easily scaled to accommodate the heat producing device 910 that may range from about 17 mm through about 45 mm in size. A profile geometry of the second clip 930 may allow a large elastic deflection capable to accommodate a heat producing device 910 height ranging from about 1.5 mm through about 4.0 mm. The Second clip 930 may reduce an air flow blockage in the heat sink 928 fin channels 928B, 928C shown in FIG. 9A.

A second clip vertical clamping feature 931 may provide a vertical clamping load between the heat sink 928 and the heat producing device 910. The second clip vertical clamping feature 931 may insure that a low thermal impedance is maintained at an interface between the heat sink 928, a thermal interface material 924, and the heat producing device 910. There are four load points, owing to each of the second clip vertical clamping feature 931, in the heat sink assembly 900. The four load points may insure a substantially uniform clamping load over the surfaces contacting the thermal interface material 924.

A second clip 930 to heat producing device 910 horizontal clamping feature 932 may provide a horizontal clamping load between the second clip 930, the first clip 910 and the heat producing device 910. The second clip 930 to heat producing device 910 horizontal clamping feature 932 may insure a long term stability of the heat sink assembly 900. There are four load points, owing to each of the first clip vertical clamping feature 932, in the heat sink assembly 900. The four load points per heat sink assembly 900 may insure an added stability of the heat sink assembly 900.

A second clip 930 to heat sink 928 lock feature 933 may provide a horizontal locking between the second clip 930 and the heat sink 928. The second clip 930 to heat sink 928 lock feature 933 may aid in stabilizing the heat sink 928 during shock and vibration loads. A second clip 930 to first clip 920 vertical lock feature 934 may provide a vertical locking between the first clip 920 and the second clip 930. A second clip 930 to first clip 920 horizontal lock feature 935 may provide a horizontal locking between the first clip 920 and the second clip 930.

A heat sink 928 may help cool the heat producing device 910. A heat sink 928 to second clip 930 horizontal lock feature 928A may provide a horizontal locking between the heat sink 928 and the second clip 930. A thermal interface material 924 may help a removal of heat from a heat producing device 910. The heat producing device 910 may require heat removal. The heat producing device 910 may have a Ball Grid Array type interconnect for attaching the first clip 920.

FIG. 9C shows a top plane view of the assembled heat sink assembly 900 shown in FIG. 9B. The first clip 920, the shaft 926, the second clip 930, and the heat sink 928 may be seen in FIG. 9C. FIG. 9D illustrates a side profile view of the assembled heat sink assembly 900 of FIG. 9B at the cross-section line AA thereby showing the heat producing device 910, the first clip 920, the second clip 930, and the heat sink 928. A Detail 2C from FIG. 9D is illustrated more clearly in FIG. 9E, thereby illustrating the heat producing device 910, the first clip 920, the locking tab 922, the pin 926, the second clip vertical clamping feature 931, the second clip 930 to heat producing device 910 horizontal clamping feature 932, and the second clip hoop 936.

FIG. 9F shows a Detail 3B of FIG. 9G where FIG. 9G illustrates another perspective view, featuring the first clip 920, the pin 926, the heat sink 928, the second clip 930, of the assembled heat sink assembly 900 shown in FIG. 9B. FIG. 9F shows the pin 926, the heat sink 928 to second clip 930 horizontal lock feature 928A, the second clip 930 to heat sink 928 lock feature 933, and the second clip 930 to first clip 920 horizontal lock feature 935.

FIG. 9H shows another perspective view of the assembled heat sink assembly 900 featuring the heat producing device 910, the first clip 920, the heat sink 928, and the second clip 930 to heat sink 928 lock feature 933. FIG. 9I shows a Detail 4B of FIG. 9H, thereby illustrating first clip 920 to second clip 930 vertical lock feature 924A, the pin 926, the second clip 930 to first clip 920 vertical lock feature 934, and the second clip 930 to first clip 920 horizontal lock feature 935.

FIG. 9J shows a side profile view of the first clip 920 including the pin 926. A Detail 5D of FIG. 9J is shown in FIG. 9K illustrating the first clip 920, the hoop 921, the first clip 920 to second clip 930 vertical lock feature 924A, the first clip ramp 925, a positive stop 925A, and the pin 926. FIG. 9L shows a perspective view of the second clip 930, including the second clip 930 to heat sink 928 lock feature 933. FIG. 9M shows a Detail 5F of FIG. 9L, thereby illustrating the second clip vertical clamping feature 931, the second clip 930 to heat producing device 910 horizontal clamping feature 932, the second clip 930 to heat sink 928 lock feature 933, and the second clip 930 to first clip 920 vertical lock feature 934. FIG. 9N shows a perspective view of the first clip 920. FIG. 9P shows a Detail 5B of FIG. 9N, thereby illustrating the first clip 920, the hoop 921, the locking tab 922, lock wedge 923, and the pin 926.

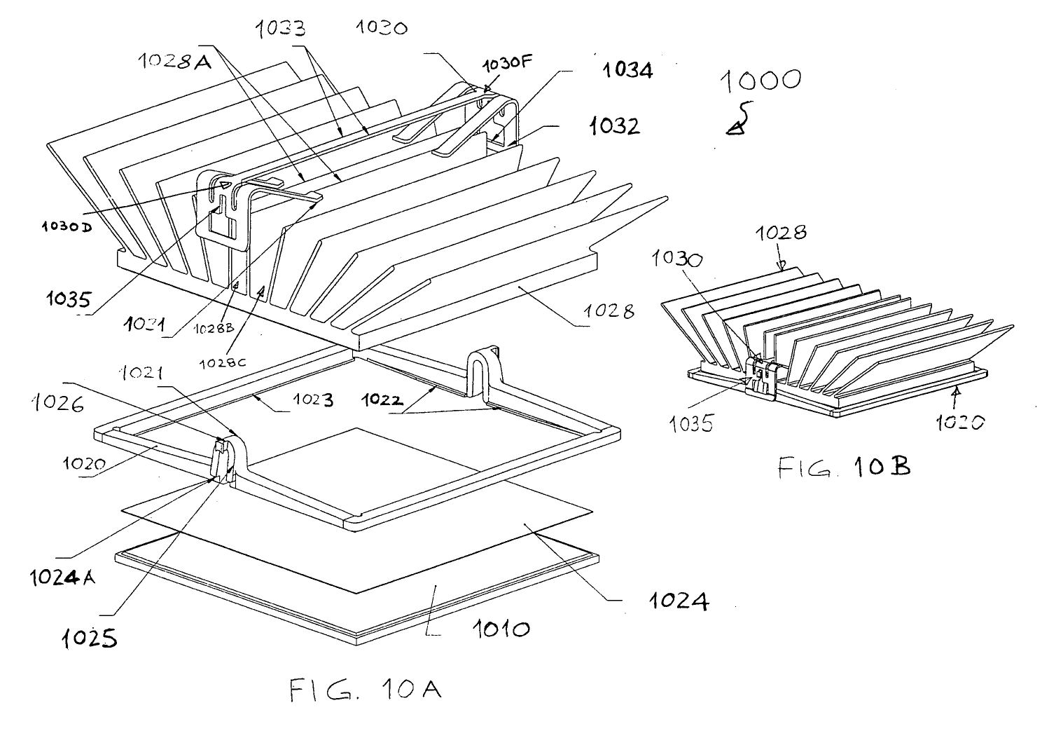

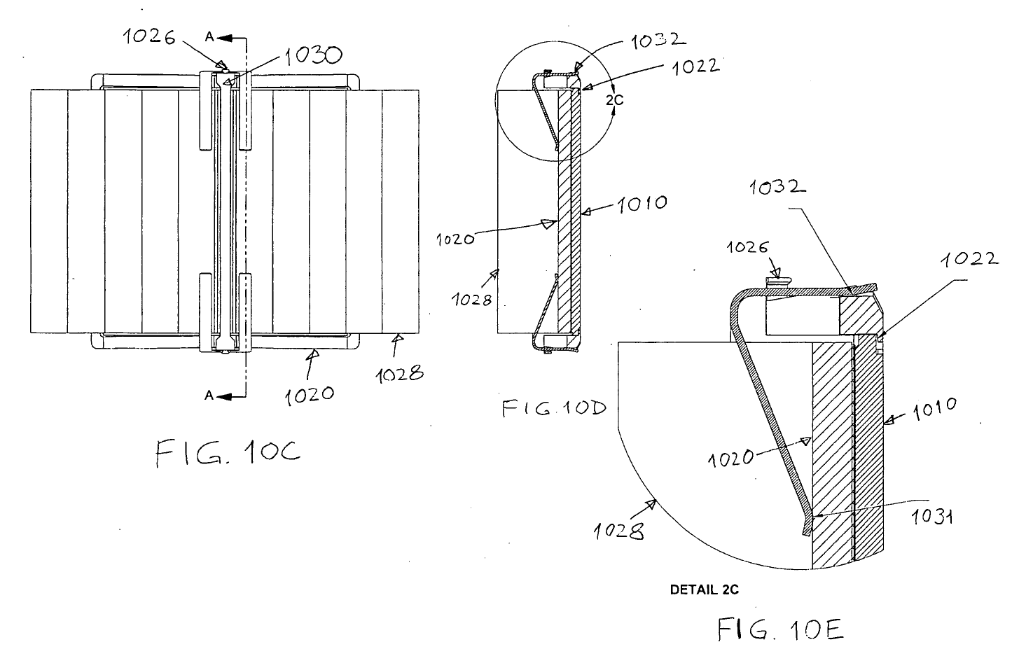

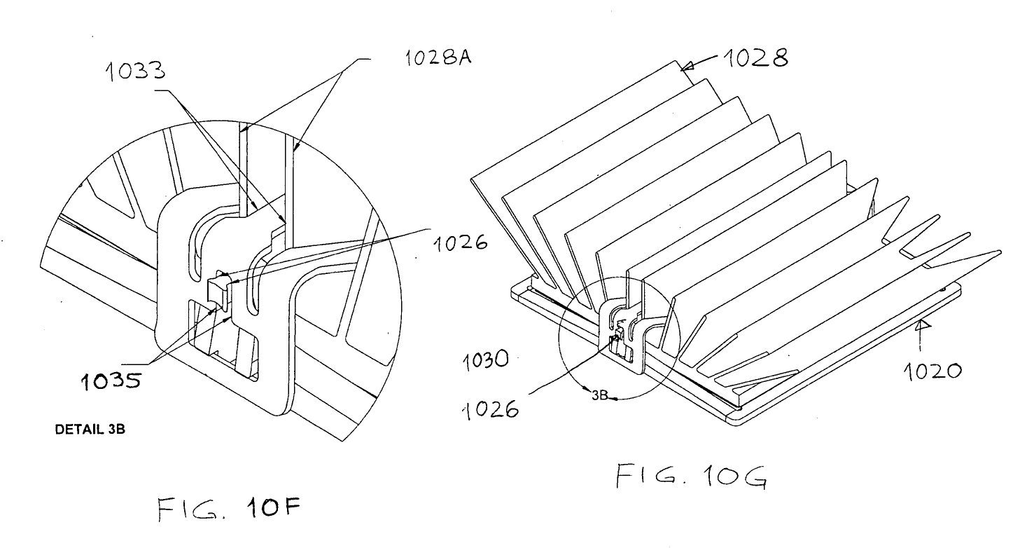

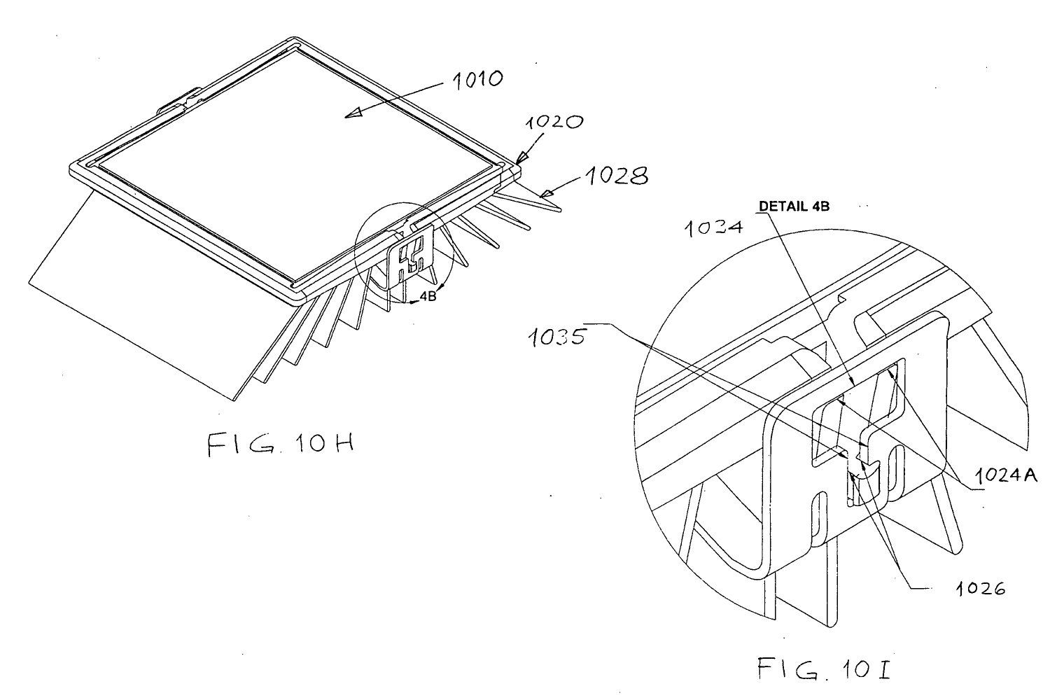

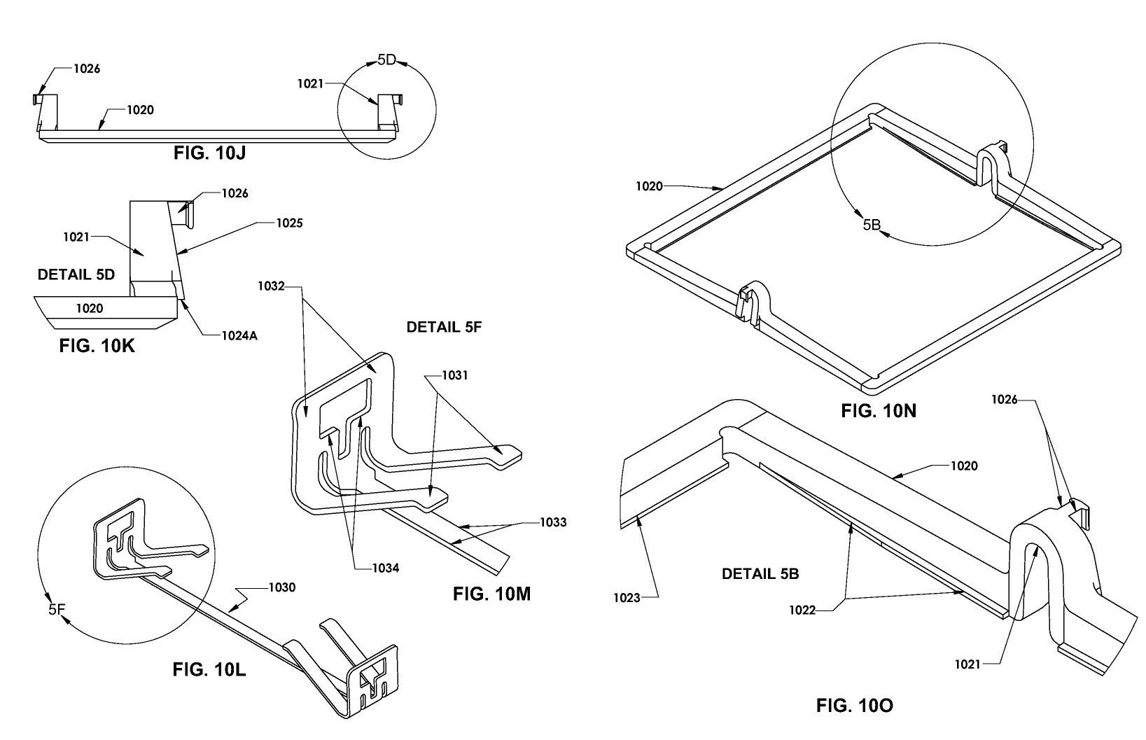

FIGS. 10A-10M, and 10N-10P illustrate several views of a heat sink assembly in accordance with another exemplary embodiment of the present invention. FIGS. 10A-10M, 10N-10P show details of various aspects of the heat sink assembly, another exemplary embodiment of the first clip, and another exemplary embodiment of the second clip.

In an exploded perspective view in FIG. 10A, various features of a heat sink assembly 1000 as another embodiment of the present disclosure, are shown as discussed below. FIG. 10B shows an assembled perspective view of the heat sink assembly 1000.

A first clip 1020 may be a part assembled to the heat producing device 1010. The first clip 1020 may provide assembly features or locking features for a second clip 1030. The first clip 1020 may be fabricated from a thermoplastic. The first clip 1020 may be designed to have a positive engagement to heat producing device 1010 along four sides, such as the at least the first edge 250, the second edge 260, the third edge 270, and the fourth edge 240 shown in FIG. 1A. The first clip 1020 may be easily scaled to accommodate the heat producing device 1010 that may range from 17 mm to 45 mm in size.

A hoop 1021, included in the first clip 1020, may allow the first clip 1020 to be placed on the heat producing device 1010 without an aid of a special tool. The hoop 1021 may aid an assembly of the first clip 1020 to the heat producing device 1010 without undergoing a substantial plastic deformation. The hoop 1021 may provide a horizontal locking between first clip 1020 and the heat sink 1028. A first clip ramp 1025, included in the hoop 1021 may aid in an easy installation of the second clip 1030 without a need for one or more special assembly tools. A locking tab 1022 may provide a vertical locking between the first clip 1020 and the heat producing device 1010. A tapered design, as more clearly shown in FIG. 10P, may help an assembly of the first clip 1020 to the heat producing device 1010 without the aid of one or more special tools. A lock wedge 1023 may provide a vertical locking between the first clip 1020 and the heat producing device 1010. Accordingly, the first clip 1020 may be configured to be included in the heat sink assembly 1000 by a human body. A first clip 1020 to second clip 1030 vertical lock feature 1024A may provide a vertical locking between the first clip 1020 and the second clip 1030. A shaft 626 may provide a horizontal locking between the first clip 1020 and the second clip 1030.

The second clip 1030 may apply a vertical clamping between the heat sink 1028 and the heat producing device 1010. The Second clip 1030 may apply a horizontal clamping between the first clip 1020 and the heat producing device 1010. The second clip 1030 may be fabricated from stainless steel. The second clip 1030 may be easily scaled to accommodate the heat producing device 1010 that may range from about 17 mm through about 45 mm in size. A profile geometry of the second clip 1030 may allow a large elastic deflection capable to accommodate a heat producing device 1010 height ranging from about 1.5 mm through about 4.0 mm. The Second clip 1030 may reduce an air flow blockage in the heat sink 1028 fin channels 1028B, 1028C shown in FIG. 10A.

A second clip vertical clamping feature 1031 may provide a vertical clamping load between the heat sink 1028 and the heat producing device 1010. The second clip vertical clamping feature 1031 may insure that a low thermal impedance is maintained at an interface between the heat sink 1028, a thermal interface material 1024, and the heat producing device 1010. There are four load points, owing to each of the second clip vertical clamping feature 1031, in the heat sink assembly 1000. The four load points may insure a substantially uniform clamping load over the surfaces contacting the thermal interface material 1024.

A second clip 1030 to heat producing device 1010 horizontal clamping feature 1032 may provide a horizontal clamping load between the second clip 1030, the first clip 1010 and the heat producing device 1010. The second clip 1030 to heat producing device 1010 horizontal clamping feature 1032 may insure a long term stability of the heat sink assembly 1000. There are four load points, owing to each of the second clip 1030 to heat producing device 1010 horizontal clamping feature 1032, in the heat sink assembly 1000. The four load points per heat sink assembly 1000 may insure an added stability of the heat sink assembly 1000.

A second clip 1030 to heat sink 1028 lock feature 1033 may provide a horizontal locking between the second clip 1030 and the heat sink 1028. The second clip 1030 to heat sink 1028 lock feature 1033 may aid in stabilizing the heat sink 1028 during shock and vibration loads. A second clip 1030 to first clip 1020 vertical lock feature 1034 may provide a vertical locking between the first clip 1020 and the second clip 1030. A second clip 1030 to first clip 1020 horizontal lock feature 1035 may provide a horizontal locking between the first clip 1020 and the second clip 1030.

A heat sink 1028 may help cool the heat producing device 1010. A heat sink 1028 to second clip 1030 horizontal lock feature 1028A may provide a horizontal locking between the heat sink 1028 and the second clip 1030. A thermal interface material 1024 may help a removal of heat from a heat producing device 1010. The heat producing device 1010 may require heat removal. The heat producing device 1010 may have a Ball Grid Array type interconnect for attaching the first clip 1020.

FIG. 10C shows a top plane view of the assembled heat sink assembly 1000 shown in FIG. 10B. The first clip 1020, the shaft 1026, the second clip 1030, and the heat sink 1028 may be seen in FIG. 6C. FIG. 10D illustrates a side profile view of the assembled heat sink assembly 1000 of FIG. 10B at the cross-section line AA thereby showing the heat producing device 1010, the first clip 1020, the locking tab 1022, the heat sink 1028, and the second clip 1030 to heat producing device 1010 horizontal clamping feature 1032. A Detail 2C from FIG. 10D is illustrated more clearly in FIG. 10E, thereby illustrating the heat producing device 1010, the first clip 1020, the locking tab 1022, the shaft 1026, the heat sink 1028, the second clip vertical clamping feature 1031, and the second clip 1030 to heat producing device 1010 horizontal clamping feature 1032.

FIG. 10F shows a Detail 3B of FIG. 10G where FIG. 10G illustrates another perspective view, featuring the first clip 1020, the shaft 1026, the heat sink 1028, and the second clip 1030, of the assembled heat sink assembly 1000 shown in FIG. 10B. FIG. 10F shows the shaft 1026, the heat sink 1028 to second clip 1030 horizontal lock feature 1028A, the second clip 1030 to heat sink 1028 lock feature 1033, and the second clip 1030 to first clip 1020 horizontal lock feature 1035.

FIG. 10H shows another perspective view of the assembled heat sink assembly 1000 featuring the heat producing device 1010, the first clip 1020, and the heat sink 1028. FIG. 10I shows a Detail 4B of FIG. 10H, thereby illustrating the first clip 1020 to second clip 1030 vertical lock feature 1024A, the shaft 1026, the second clip 1030 to first clip 1020 vertical lock feature 1034, and the second clip 1030 to first clip 1020 horizontal lock feature 1035.

FIG. 10J shows a side profile view of the first clip 1020 including the hoop 1021 and the shaft 1026. A Detail 5D of FIG. 10J is shown in FIG. 10K illustrating the first clip 1020, the hoop 1021, the first clip 1020 to second clip 1030 vertical lock feature 1024A, the first clip ramp 1025, and the shaft 1026. FIG. 10L shows a perspective view of the second clip 1030. FIG.10M shows a Detail 5F of FIG. 10L, thereby illustrating the second clip vertical clamping feature 1031, the second clip 1030 to heat producing device 1010 horizontal clamping feature 1032, the second clip 1030 to heat sink 1028 lock feature 1033, and the second clip 1030 to first clip 1020 vertical lock feature 1034. FIG. 10N shows a perspective view of the first clip 1020. FIG. 10P shows a Detail 5B of FIG. 10N, thereby illustrating the first clip 1020, the hoop 1021, the locking tab 1022, lock wedge 1023, and the shaft 1026.

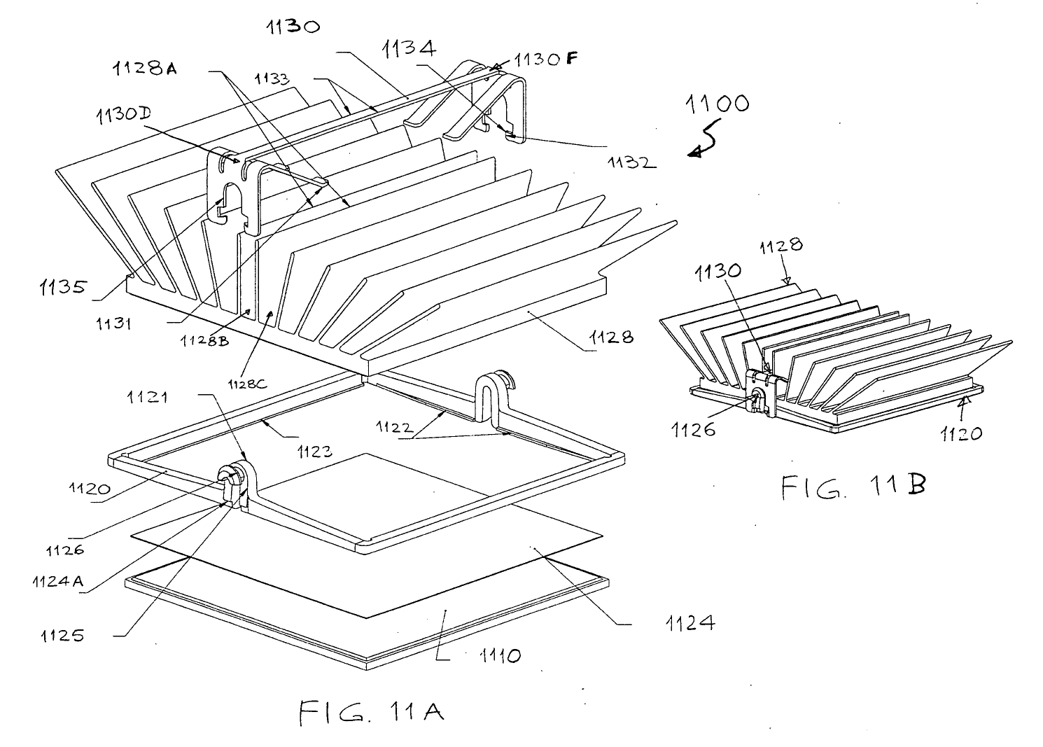

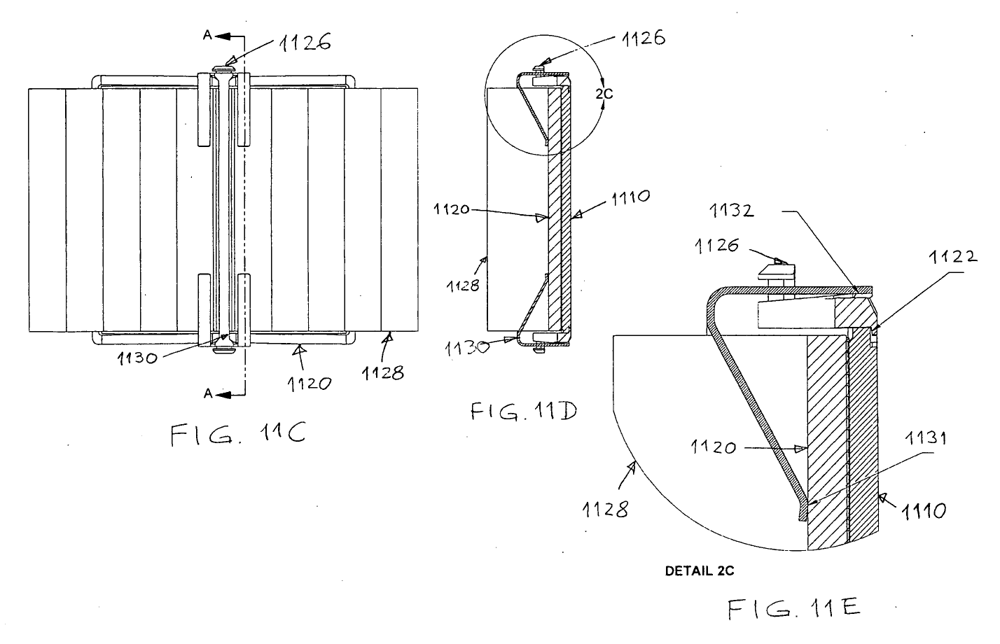

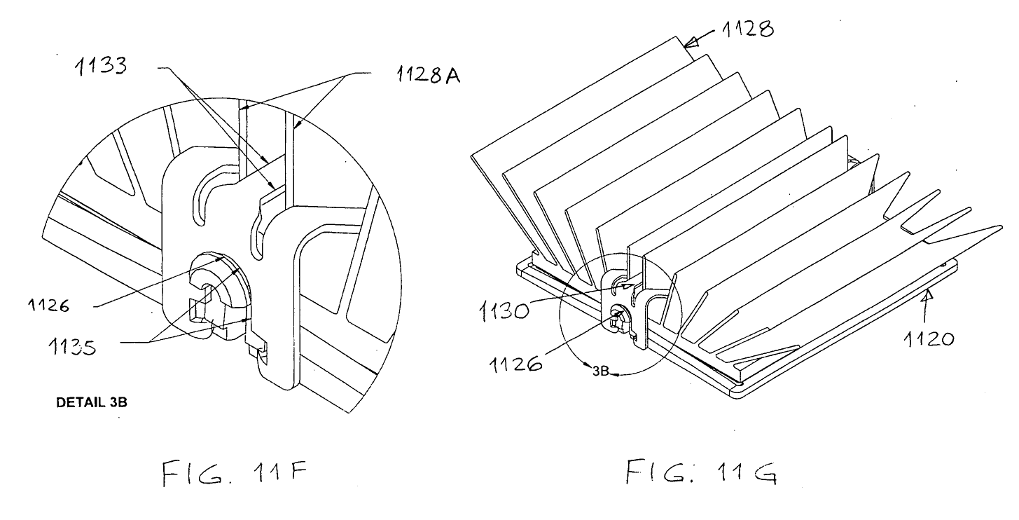

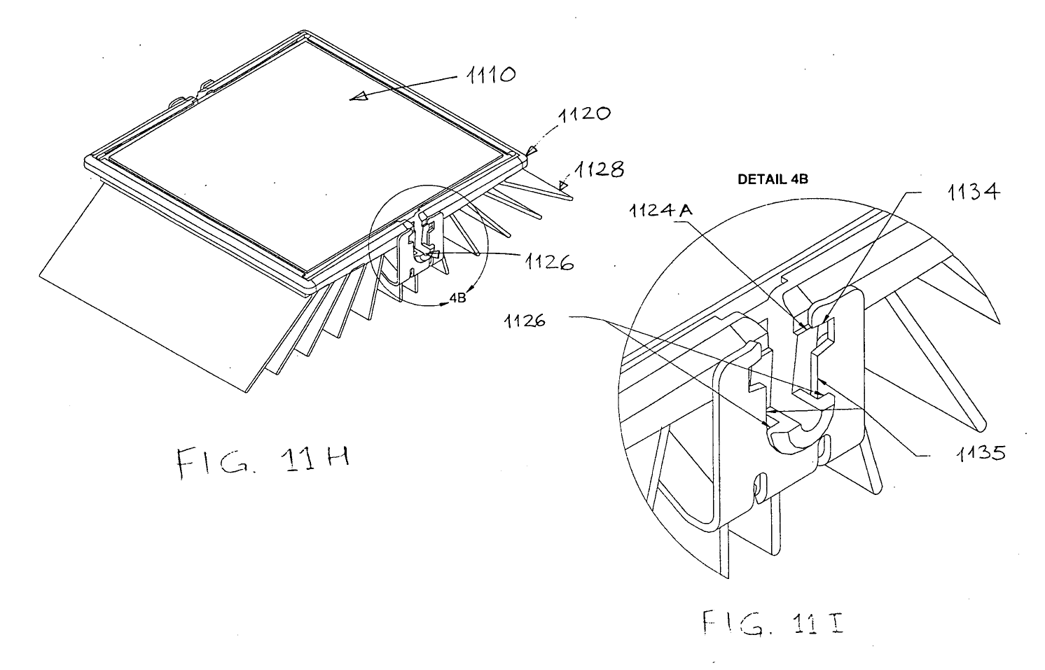

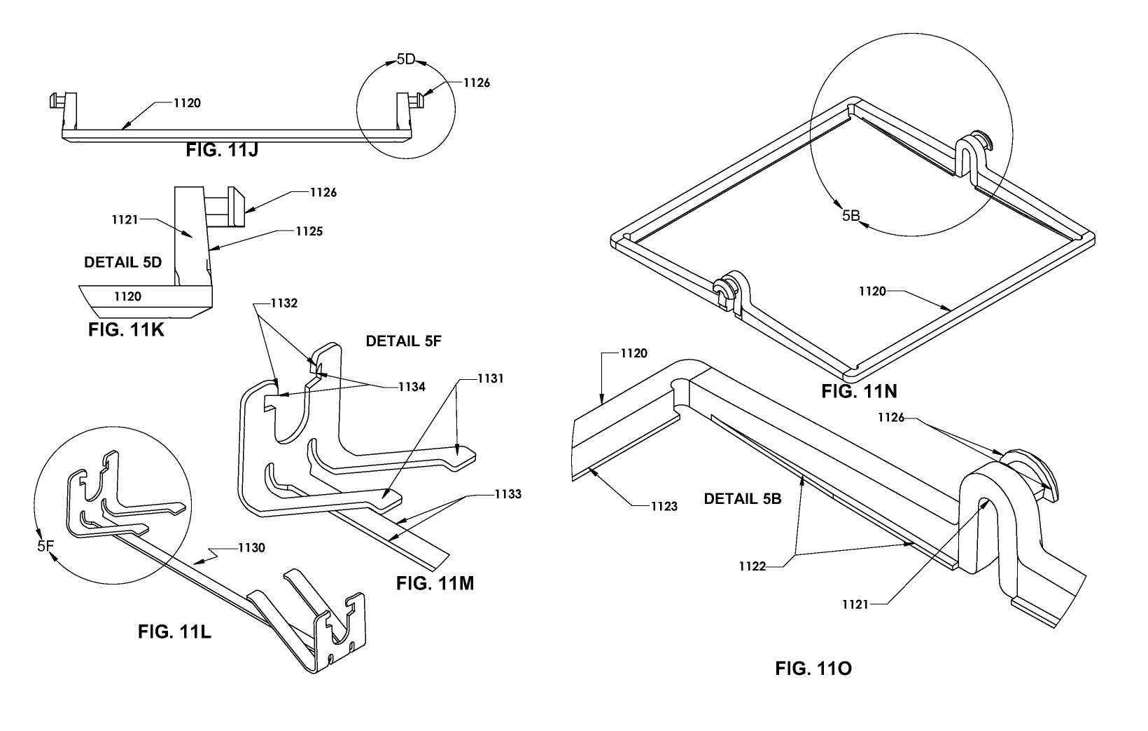

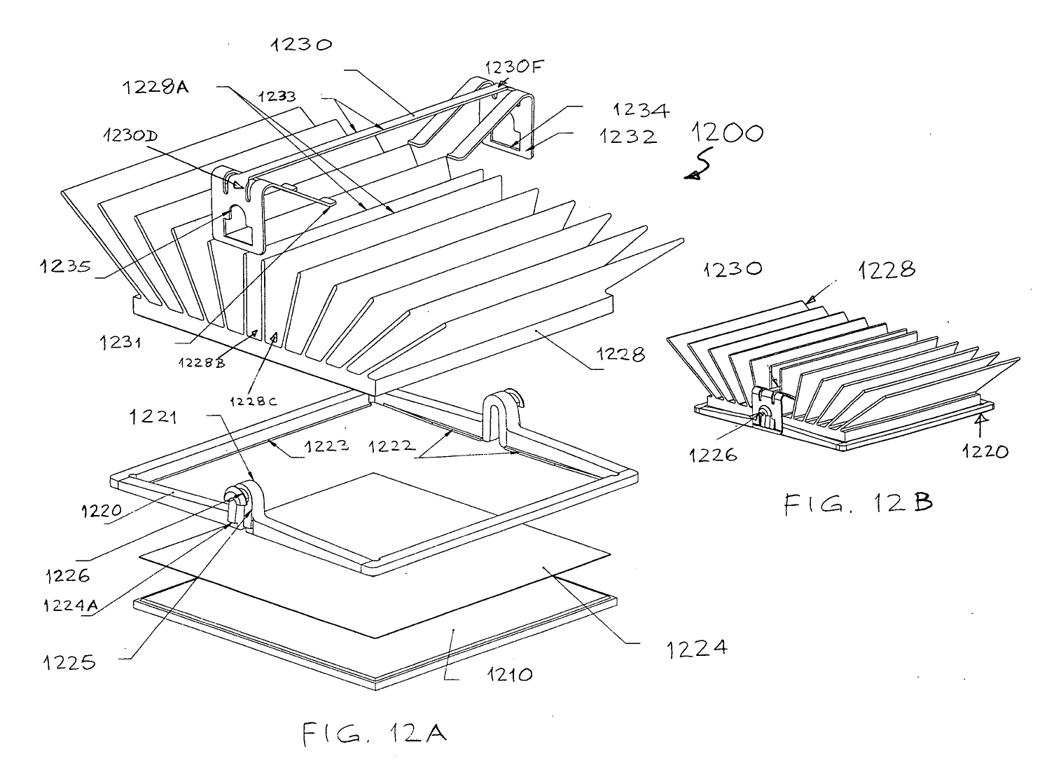

FIGS. 11A-11M, and 11N-11P illustrate several views of a heat sink assembly in accordance with another exemplary embodiment of the present invention. FIGS. 11A-11M, 11N-11P show details of various aspects of the heat sink assembly, another exemplary embodiment of the first clip, and another exemplary embodiment of the second clip.

In an exploded perspective view in FIG. 11A, various features of a heat sink assembly 1100 as another embodiment of the present disclosure, are shown as discussed below. FIG. 11B shows an assembled perspective view of the heat sink assembly 1100.

A first clip 1120 may be a part assembled to the heat producing device 1110. The first clip 1120 may provide assembly features or locking features for a second clip 1130. The first clip 1120 may be fabricated from a thermoplastic. The first clip 1120 may be designed to have a positive engagement to heat producing device 1110 along four sides, such as the at least the first edge 250, the second edge 260, the third edge 270, and the fourth edge 240 shown in FIG. 1A. The first clip 1120 may be easily scaled to accommodate the heat producing device 1110 that may range from 17 mm to 45 mm in size.

A hoop 1121, included in the first clip 1120, may allow the first clip 1120 to be placed on the heat producing device 1110 without an aid of a special tool. The hoop 1121 may aid an assembly of the first clip 1120 to the heat producing device 1110 without undergoing a substantial plastic deformation. The hoop 1121 may provide a horizontal locking between first clip 1120 and the heat sink 1128. A first clip ramp 1125, included in the hoop 1121 may aid in an easy installation of the second clip 1130 without a need for one or more special assembly tools. A locking tab 1122 may provide a vertical locking between the first clip 1120 and the heat producing device 1110. A tapered design, as more clearly shown in FIG. 11P, may help an assembly of the first clip 1120 to the heat producing device 1110 without the aid of one or more special tools. A lock wedge 1123 may provide a vertical locking between the first clip 1120 and the heat producing device 1110. Accordingly, the first clip 1120 may be configured to be included in the heat sink assembly 1100 by a human body. A first clip 1120 to second clip 1130 vertical lock feature 1124A may provide a vertical locking between the first clip 1120 and the second clip 1130. A shaft 1126 may provide a horizontal locking between the first clip 1120 and the second clip 1130.

The second clip 1130 may apply a vertical clamping between the heat sink 1128 and the heat producing device 1110. The Second clip 1130 may apply a horizontal clamping between the first clip 1120 and the heat producing device 1110. The second clip 1130 may be fabricated from stainless steel. The second clip 1130 may be easily scaled to accommodate the heat producing device 1110 that may range from about 17 mm through about 45 mm in size. A profile geometry of the second clip 1130 may allow a large elastic deflection capable to accommodate a heat producing device 1110 height ranging from about 1.5 mm through about 4.0 mm. The Second clip 1130 may reduce an air flow blockage in the heat sink 1128 fin channels 1128B, 1128C shown in FIG. 11A.

A second clip vertical clamping feature 1131 may provide a vertical clamping load between the heat sink 1128 and the heat producing device 1110. The second clip vertical clamping feature 1131 may insure that a low thermal impedance is maintained at an interface between the heat sink 1128, a thermal interface material 1124, and the heat producing device 1110. There are four load points, owing to each of the second clip vertical clamping feature 1131, in the heat sink assembly 1100. The four load points may insure a substantially uniform clamping load over the surfaces contacting the thermal interface material 1124.

A second clip 1130 to heat producing device 1110 horizontal clamping feature 1132 may provide a horizontal clamping load between the second clip 1130, the first clip 1110 and the heat producing device 1110. The second clip 1130 to heat producing device 1110 horizontal clamping feature 1132 may insure a long term stability of the heat sink assembly 1100. There are four load points, owing to each of the second clip 1130 to heat producing device 1110 horizontal clamping feature 1132, in the heat sink assembly 1100. The four load points per heat sink assembly 1100 may insure an added stability of the heat sink assembly 1100.

A second clip 1130 to heat sink 1128 lock feature 1133 may provide a horizontal locking between the second clip 1130 and the heat sink 1128. The second clip 1130 to heat sink 1128 lock feature 1133 may aid in stabilizing the heat sink 1128 during shock and vibration loads. A second clip 1130 to first clip 1120 vertical lock feature 1134 may provide a vertical locking between the first clip 1120 and the second clip 1130. A second clip 1130 to first clip 1120 horizontal lock feature 1135 may provide a horizontal locking between the first clip 1120 and the second clip 1130.

A heat sink 1128 may help cool the heat producing device 1110. A heat sink 1128 to second clip 1130 horizontal lock feature 1128A may provide a horizontal locking between the heat sink 1128 and the second clip 1130. A thermal interface material 1124 may help a removal of heat from a heat producing device 1110. The heat producing device 1110 may require heat removal. The heat producing device 1110 may have a Ball Grid Array type interconnect for attaching the first clip 1120.

FIG. 11C shows a top plane view of the assembled heat sink assembly 1100 shown in FIG. 11B. The first clip 1120, the shaft 1126, the second clip 1130, and the heat sink 1128 may be seen in FIG. 11C. FIG. 11D illustrates a side profile view of the assembled heat sink assembly 1100 of FIG. 11B at the cross-section line AA thereby showing the heat producing device 1110, the first clip 1120, the second clip 1130, the shaft 1126, and the heat sink 1128. A Detail 2C from FIG. 11D is illustrated more clearly in FIG. 11E, thereby illustrating the heat producing device 1110, the first clip 1120, the locking tab 1122, the shaft 1126, the heat sink 1128, the second clip vertical clamping feature 1131, the second clip 1130 to heat producing device 1110 horizontal clamping feature 1132.

FIG. 11F shows a Detail 3B of FIG. 11G where FIG. 11G illustrates another perspective view, featuring the first clip 1120, the shaft 1126, the heat sink 1128, and the second clip 1130, of the assembled heat sink assembly 1100 shown in FIG. 11B. FIG. 11F shows the shaft 1126, the heat sink 1128 to second clip 1130 horizontal lock feature 1128A, the second clip 1130 to heat sink 1128 lock feature 1133, and the second clip 1130 to first clip 1120 horizontal lock feature 1135.

FIG. 11H shows another perspective view of the assembled heat sink assembly 1100 featuring the heat producing device 1110, the first clip 1120, the shaft 1126, and the heat sink 1128. FIG. 11I shows a Detail 4B of FIG. 11H, thereby illustrating the first clip 1120 to second clip 1130 vertical lock feature 1124A, the shaft 1126, the second clip 1130 to first clip 1120 vertical lock feature 1134, and the second clip 1130 to first clip 1120 horizontal lock feature 1135.

FIG. 11J shows a side profile view of the first clip 1120 including the shaft 1126. A Detail 5D of FIG. 11J is shown in FIG. 11K illustrating the first clip 1120, the hoop 1121, the first clip ramp 1125, and the shaft 1126. FIG. 11L shows a perspective view of the second clip 1130. FIG. 11M shows a Detail 5F of FIG. 11L, thereby illustrating the second clip vertical clamping feature 1131, the second clip 1130 to heat producing device 1110 horizontal clamping feature 1132, the second clip 1130 to heat sink 1128 lock feature 1133, and the second clip 1130 to first clip 1120 vertical lock feature 1134. FIG. 11N shows a perspective view of the first clip 1120. FIG. 11P shows a Detail 5B of FIG. 11N, thereby illustrating the first clip 1120, the hoop 1121, the locking tab 1122, lock wedge 1123, and the shaft 1126.

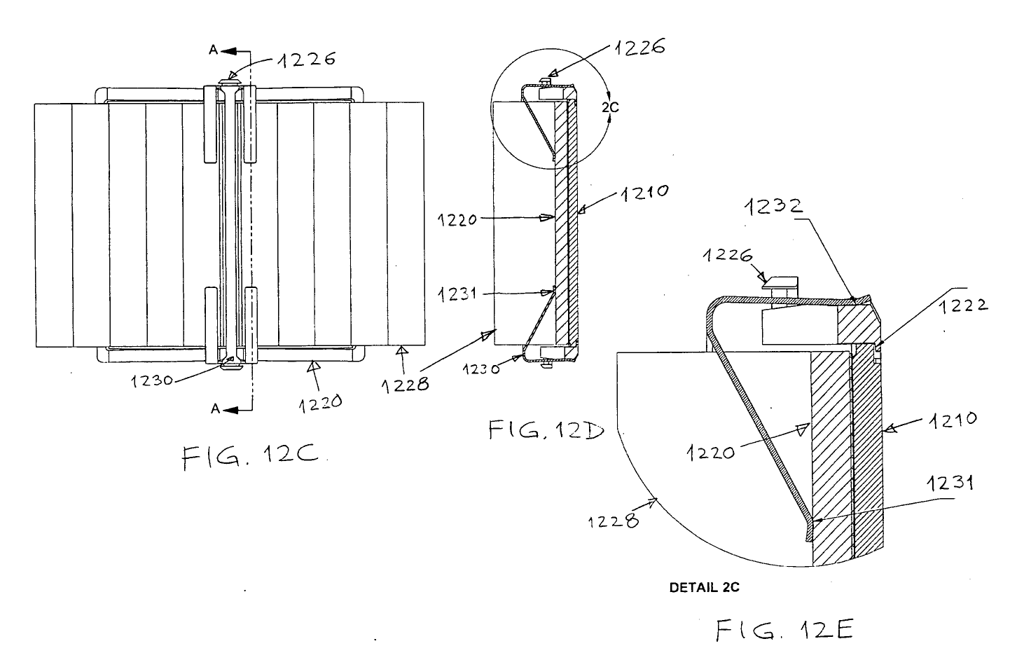

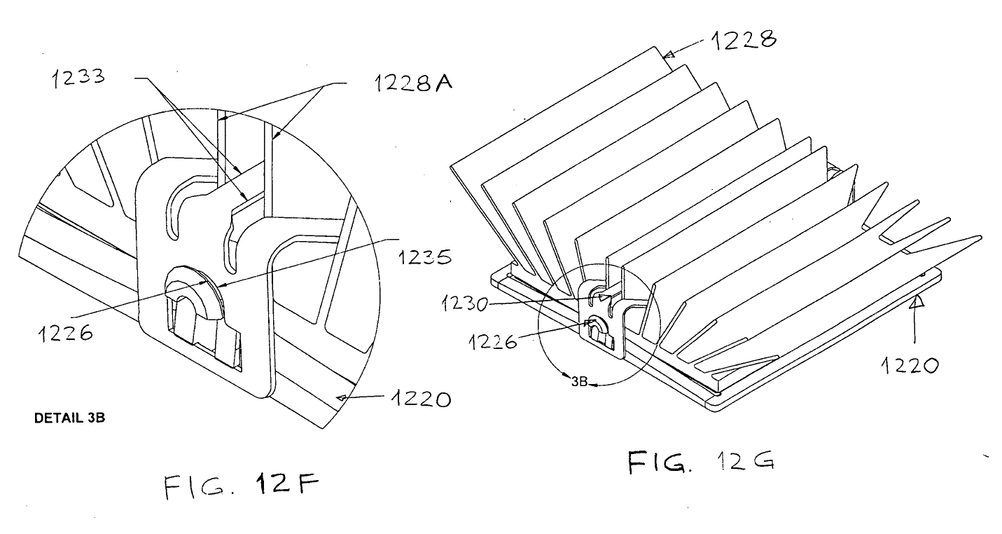

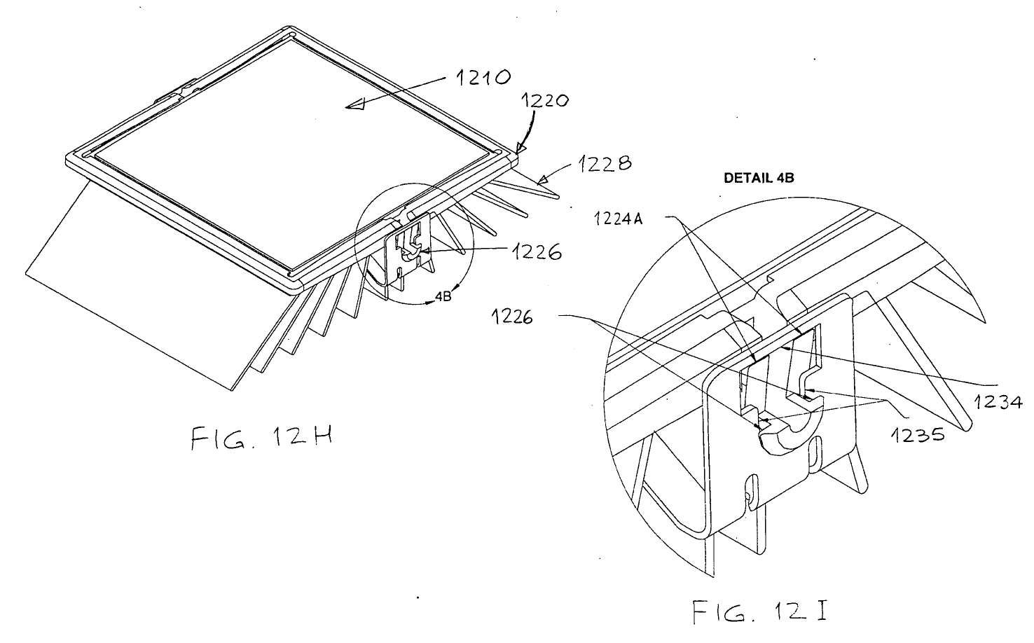

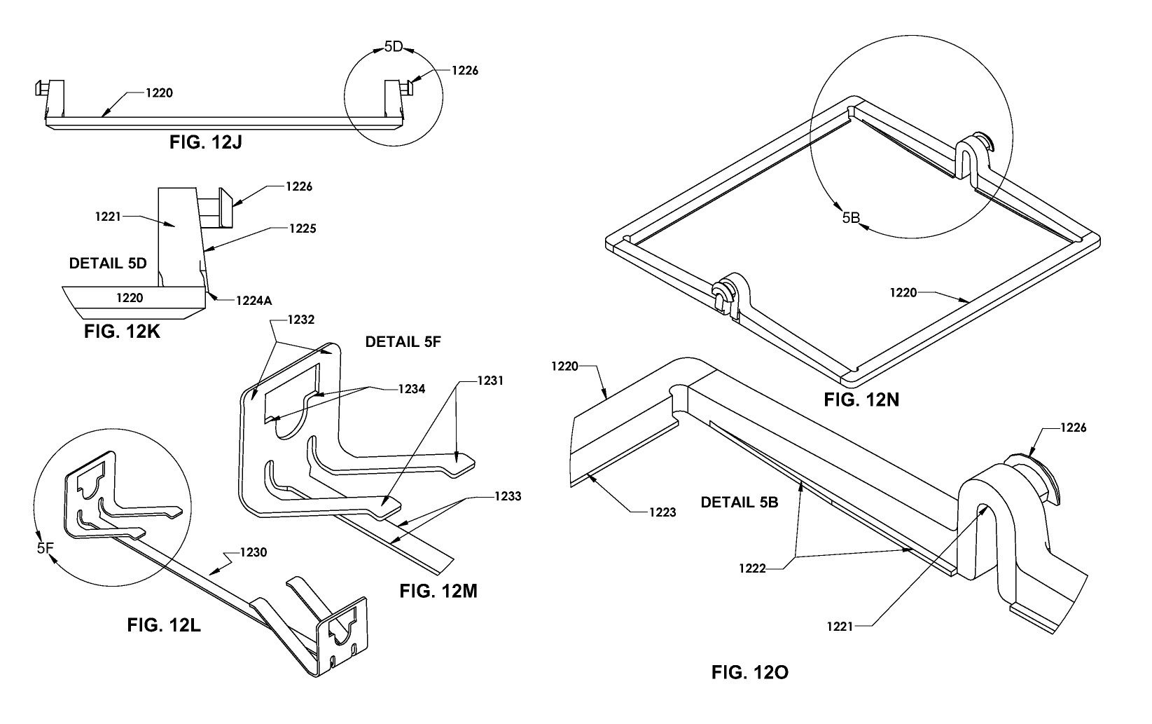

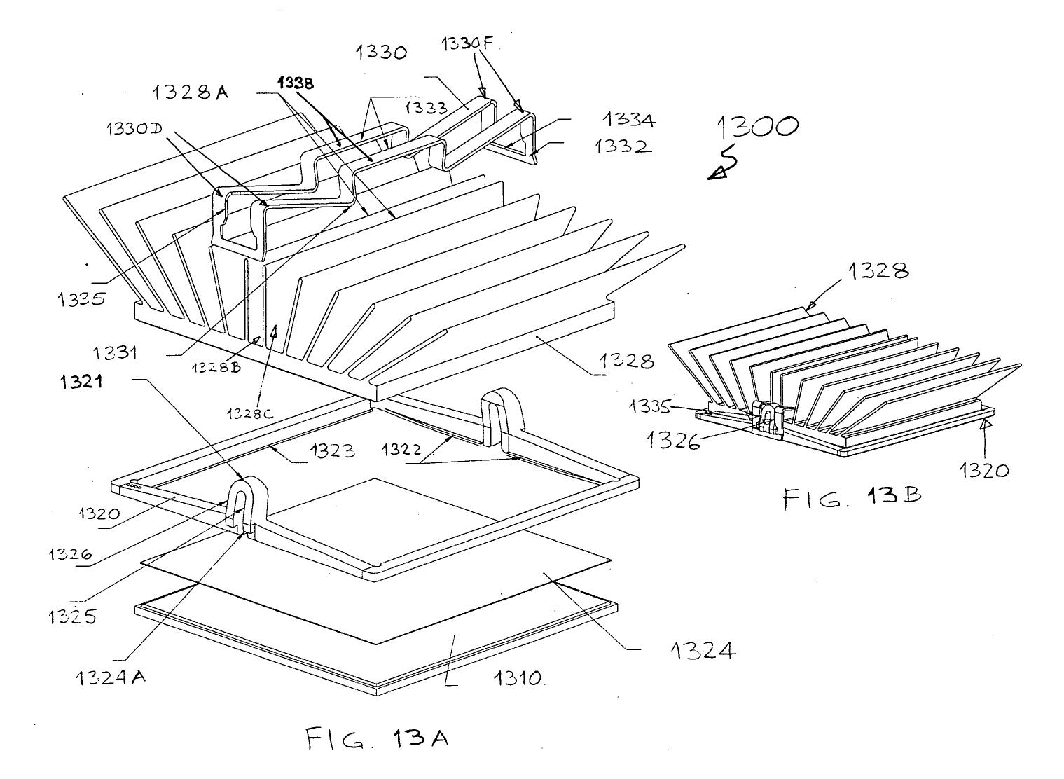

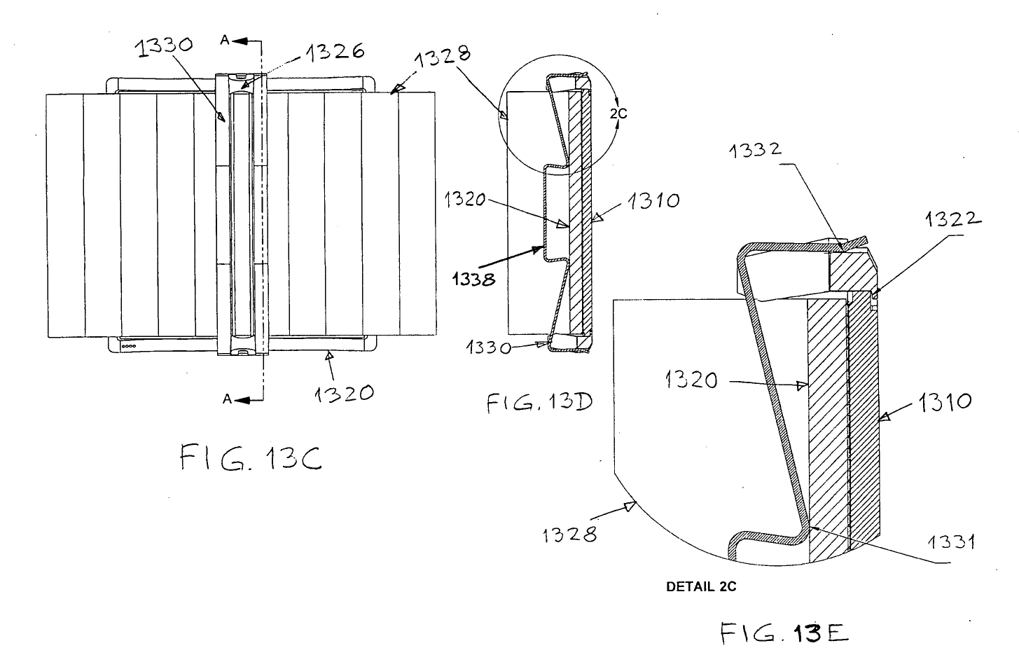

FIGS. 12A-12M, and 12N-12P illustrate several views of a heat sink assembly in accordance with another exemplary embodiment of the present invention. FIGS. 12A-12M, 12N-12P show details of various aspects of the heat sink assembly, another exemplary embodiment of the first clip, and another exemplary embodiment of the second clip.

In an exploded perspective view in FIG. 12A, various features of a heat sink assembly 1200 as another embodiment of the present disclosure, are shown as discussed below. FIG. 12B shows an assembled perspective view of the heat sink assembly 1200.

A first clip 1220 may be a part assembled to the heat producing device 1210. The first clip 1220 may provide assembly features or locking features for a second clip 1230. The first clip 1220 may be fabricated from a thermoplastic. The first clip 1220 may be designed to have a positive engagement to heat producing device 1210 along four sides, such as the at least the first edge 250, the second edge 260, the third edge 270, and the fourth edge 240 shown in FIG. 1A. The first clip 1220 may be easily scaled to accommodate the heat producing device 1210 that may range from 17 mm to 45 mm in size.

A hoop 1221, included in the first clip 1220, may allow the first clip 1220 to be placed on the heat producing device 1210 without an aid of a special tool. The hoop 1221 may aid an assembly of the first clip 1220 to the heat producing device 1210 without undergoing a substantial plastic deformation. The hoop 1221 may provide a horizontal locking between first clip 1220 and the heat sink 1228. A first clip ramp 1225, included in the hoop 1221 may aid in an easy installation of the second clip 1230 without a need for one or more special assembly tools. A locking tab 1222 may provide a vertical locking between the first clip 1220 and the heat producing device 1210. A tapered design, as more clearly shown in FIG. 12P, may help an assembly of the first clip 1220 to the heat producing device 1210 without the aid of one or more special tools. A lock wedge 1223 may provide a vertical locking between the first clip 1220 and the heat producing device 1210. Accordingly, the first clip 1220 may be configured to be included in the heat sink assembly 1200 by a human body. A first clip 1220 to second clip 1230 vertical lock feature 1224A may provide a vertical locking between the first clip 1220 and the second clip 1230. A shaft 626 may provide a horizontal locking between the first clip 1220 and the second clip 1230.

The second clip 1230 may apply a vertical clamping between the heat sink 1228 and the heat producing device 1210. The Second clip 1230 may apply a horizontal clamping between the first clip 1220 and the heat producing device 1210. The second clip 1230 may be fabricated from stainless steel. The second clip 1230 may be easily scaled to accommodate the heat producing device 1210 that may range from about 17 mm through about 45 mm in size. A profile geometry of the second clip 1230 may allow a large elastic deflection capable to accommodate a heat producing device 1210 height ranging from about 1.5 mm through about 4.0 mm. The Second clip 1230 may reduce an air flow blockage in the heat sink 1228 fin channels 1228B, 1228C shown in FIG. 12A.

A second clip vertical clamping feature 1231 may provide a vertical clamping load between the heat sink 1228 and the heat producing device 1210. The second clip vertical clamping feature 1231 may insure that a low thermal impedance is maintained at an interface between the heat sink 1228, a thermal interface material 1224, and the heat producing device 1210. There are four load points, owing to each of the second clip vertical clamping feature 1231, in the heat sink assembly 1200. The four load points may insure a substantially uniform clamping load over the surfaces contacting the thermal interface material 1224.

A second clip 1230 to heat producing device 1210 horizontal clamping feature 1232 may provide a horizontal clamping load between the second clip 1230, the first clip 1210 and the heat producing device 1210. The second clip 1230 to heat producing device 1210 horizontal clamping feature 1232 may insure a long term stability of the heat sink assembly 1200. There are four load points, owing to each of the first clip vertical clamping feature 1232, in the heat sink assembly 1200. The four load points per heat sink assembly 1200 may insure an added stability of the heat sink assembly 1200.

A second clip 1230 to heat sink 1228 lock feature 1233 may provide a horizontal locking between the second clip 1230 and the heat sink 1228. The second clip 1230 to heat sink 1228 lock feature 1233 may aid in stabilizing the heat sink 1228 during shock and vibration loads. A second clip 1230 to first clip 1220 vertical lock feature 1234 may provide a vertical locking between the first clip 1220 and the second clip 1230. A second clip 1230 to first clip 1220 horizontal lock feature 1235 may provide a horizontal locking between the first clip 1220 and the second clip 1230.

A heat sink 1228 may help cool the heat producing device 1210. A heat sink 1228 to second clip 1230 horizontal lock feature 1228A may provide a horizontal locking between the heat sink 1228 and the second clip 1230. A thermal interface material 1224 may help a removal of heat from a heat producing device 1210. The heat producing device 1210 may require heat removal. The heat producing device 1210 may have a Ball Grid Array type interconnect for attaching the first clip 1220.

FIG. 12C shows a top plane view of the assembled heat sink assembly 1200 shown in FIG. 12B. The first clip 1220, the shaft 1226, the second clip 1230, and the heat sink 1228 may be seen in FIG. 12C. FIG. 12D illustrates a side profile view of the assembled heat sink assembly 1200 of FIG. 12B at the cross-section line AA thereby showing the heat producing device 1210, the first clip 1220, the second clip 1230, the second clip vertical clamping feature 1231, the shaft 1226, and the heat sink 1228. A Detail 2C from FIG. 12D is illustrated more clearly in FIG. 12E, thereby illustrating the heat producing device 1210, the first clip 1220, the locking tab 1222, the shaft 1226, the heat sink 1228, the second clip vertical clamping feature 1231, the second clip 1230 to heat producing device 1210 horizontal clamping feature 1232.

FIG. 12F shows a Detail 3B of FIG. 12G where FIG. 12G illustrates another perspective view, featuring the first clip 1220, the shaft 1226, the heat sink 1228, and the second clip 1230, of the assembled heat sink assembly 1200 shown in FIG. 12B. FIG. 12F shows the first clip 1220, the shaft 1226, the heat sink 1228 to second clip 1230 horizontal lock feature 1228A, the second clip 1230 to heat sink 1228 lock feature 1233, and the second clip 1230 to first clip 1220 horizontal lock feature 1235.

FIG. 12H shows another perspective view of the assembled heat sink assembly 1200 featuring the heat producing device 1210, the first clip 1220, the shaft 1226, and the heat sink 1228. FIG. 12I shows a Detail 4B of FIG. 12H, thereby illustrating the first clip 1220 to second clip 1230 vertical lock feature 1224A, the shaft 1226, the second clip 1230 to first clip 1220 vertical lock feature 1234, and the second clip 1230 to first clip 1220 horizontal lock feature 1235.

FIG. 12J shows a side profile view of the first clip 1220 including the shaft 1226. A Detail 5D of FIG. 12J is shown in FIG. 12K illustrating the first clip 1220, the hoop 1221, the first clip ramp 1225, and the shaft 1226. FIG. 12L shows a perspective view of the second clip 1230. FIG. 12M shows a Detail 5F of FIG. 12L, thereby illustrating the second clip vertical clamping feature 1231, the second clip 1230 to heat producing device 1210 horizontal clamping feature 1232, the second clip 1230 to heat sink 1228 lock feature 1233, and the second clip 1230 to first clip 1220 vertical lock feature 1234. FIG. 12N shows a perspective view of the first clip 1220. FIG. 12P shows a Detail 5B of FIG. 12N, thereby illustrating the first clip 1220, the hoop 1221, the locking tab 1222, lock wedge 1223, and the shaft 1226.

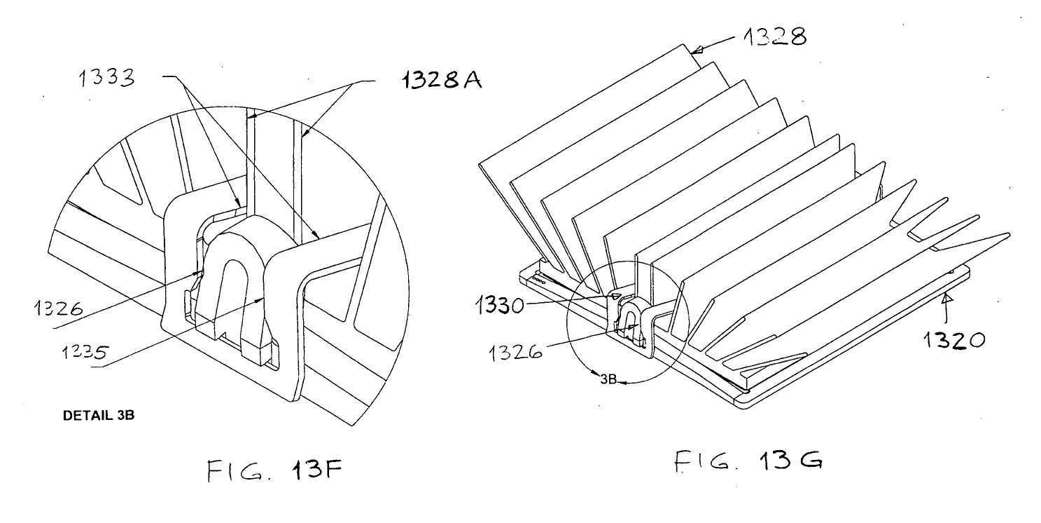

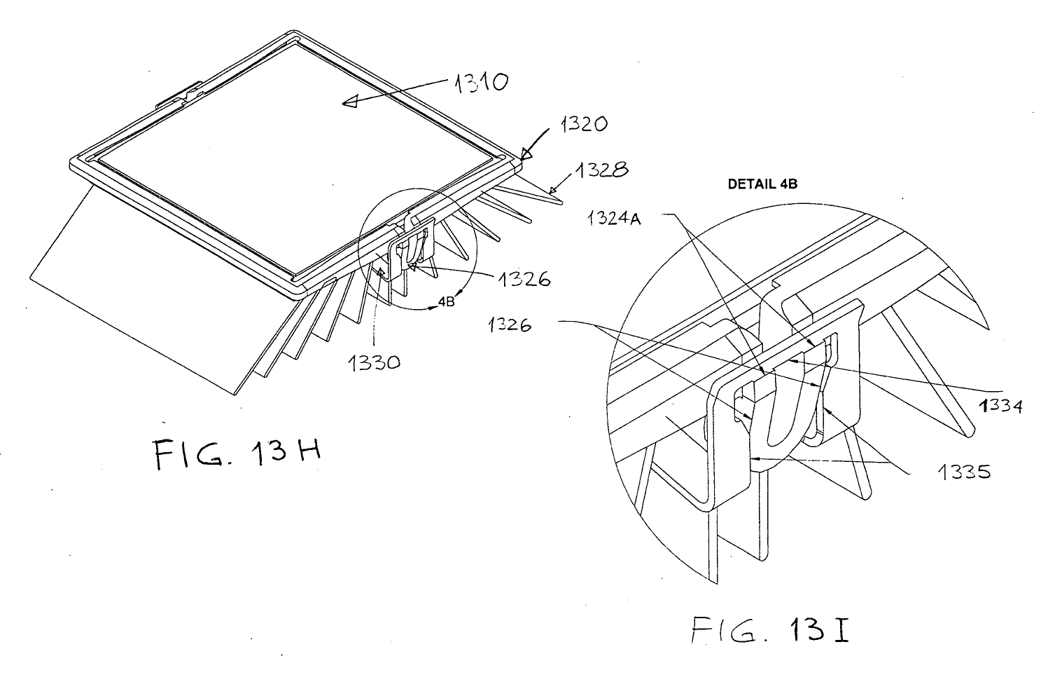

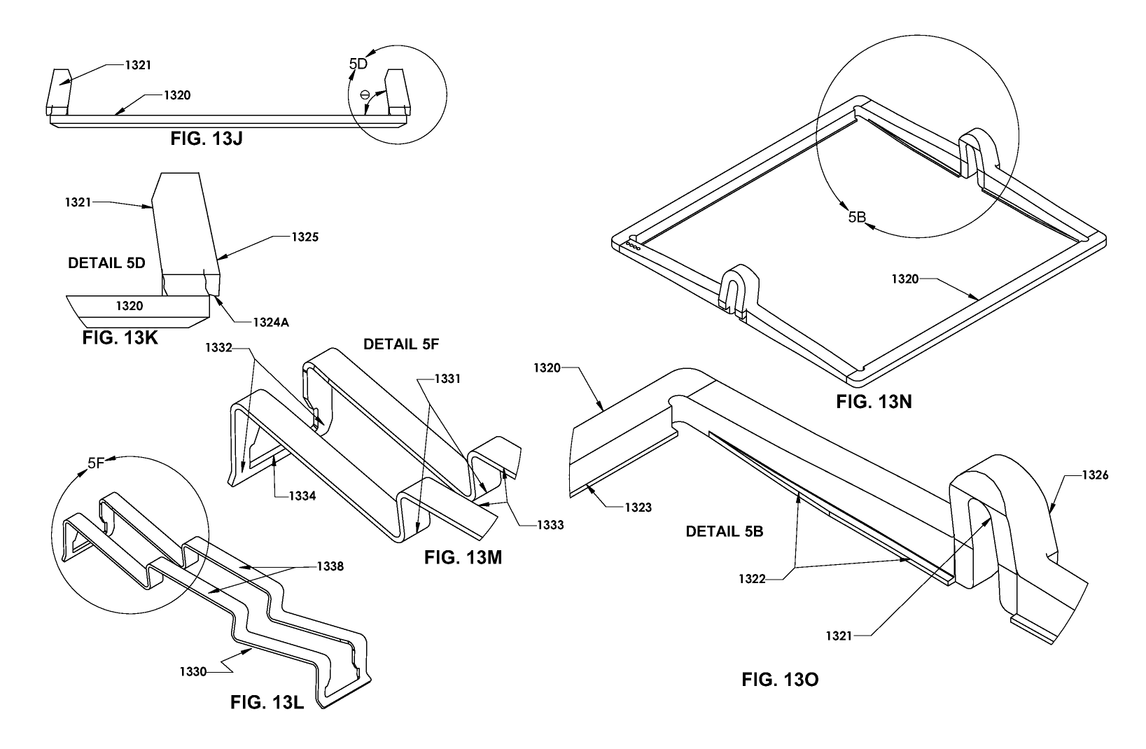

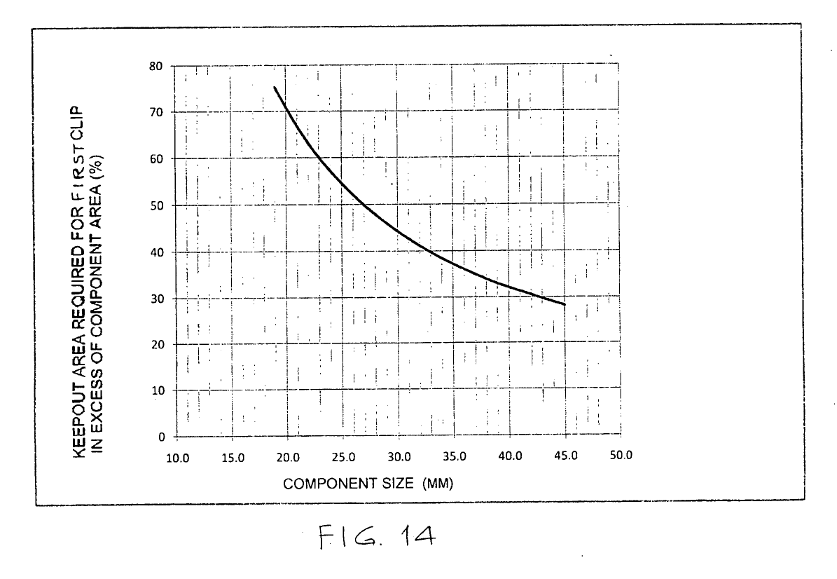

FIGS. 13A-13M, and 13N-13P illustrate several views of a heat sink assembly in accordance with another exemplary embodiment of the present invention. FIGS. 13A-13M, 13N-13P show details of various aspects of the heat sink assembly, another exemplary embodiment of the first clip, and another exemplary embodiment of the second clip.

In an exploded perspective view in FIG. 13A, various features of a heat sink assembly 1300 as another embodiment of the present disclosure, are shown as discussed below. FIG. 13B shows an assembled perspective view of the heat sink assembly 1300.

A first clip 1320 may be a part assembled to the heat producing device 1310. The first clip 1320 may provide assembly features or locking features for a second clip 1330. The first clip 1320 may be fabricated from a thermoplastic. The first clip 1320 may be designed to have a positive engagement to heat producing device 1310 along four sides, such as the at least the first edge 250, the second edge 260, the third edge 270, and the fourth edge 240 shown in FIG. 1A. The first clip 1320 may be easily scaled to accommodate the heat producing device 1310 that may range from 17 mm to 45 mm in size.

A hoop 1321, included in the first clip 1320, may allow the first clip 1320 to be placed on the heat producing device 1310 without an aid of a special tool. The hoop 1321 may aid an assembly of the first clip 1320 to the heat producing device 1310 without undergoing a substantial plastic deformation. The hoop 1321 may provide a horizontal locking between first clip 1320 and the heat sink 1328. A first clip ramp 1325, included in the hoop 1321 may aid in an easy installation of the second clip 1330 without a need for one or more special assembly tools. A locking tab 1322 may provide a vertical locking between the first clip 1320 and the heat producing device 1310. A tapered design, as more clearly shown in FIG. 13P, may help an assembly of the first clip 1320 to the heat producing device 1310 without the aid of one or more special tools. A lock wedge 1323 may provide a vertical locking between the first clip 1320 and the heat producing device 1310. Accordingly, the first clip 1320 may be configured to be included in the heat sink assembly 1300 by a human body. A first clip 1320 to second clip 1330 vertical lock feature 1324A may provide a vertical locking between the first clip 1320 and the second clip 1330. A first clip 1320 to second clip 1330 horizontal lock feature 1326 may provide a horizontal locking between the first clip 1320 and the second clip 1330.

The second clip 1330 may apply a vertical clamping between the heat sink 1328 and the heat producing device 1310. The Second clip 1330 may apply a horizontal clamping between the first clip 1320 and the heat producing device 1310. The second clip 1330 may be fabricated from stainless steel.

The second clip 1330 may be easily scaled to accommodate the heat producing device 1310 that may range from about 17 mm through about 45 mm in size. A profile geometry of the second clip 1330 may allow a large elastic deflection capable to accommodate a heat producing device 1310 height ranging from about 1.5 mm through about 4.0 mm. A profile geometry having an inverted base 1338, shown in FIGS. 13A, 13D, and 13L, may allow a large elastic deflection which may accommodate the heat producing device 1310 height ranging from about 1.5 mm through 4.0 mm. The Second clip 1330 may reduce an air flow blockage in the heat sink 1328 fin channels 1328B, 1328C shown in FIG. 13A.

A second clip vertical clamping feature 1331 may provide a vertical clamping load between the heat sink 1328 and the heat producing device 1310. The second clip vertical clamping feature 1331 may insure that a low thermal impedance is maintained at an interface between the heat sink 1328, a thermal interface material 1324, and the heat producing device 1310. There are four load points, owing to each of the second clip vertical clamping feature 1331, in the heat sink assembly 1300. The four load points may insure a substantially uniform clamping load over the surfaces contacting the thermal interface material 1324.

A second clip 1330 to heat producing device 1310 horizontal clamping feature 1332 may provide a horizontal clamping load between the second clip 1330, the first clip 1310 and the heat producing device 1310. The second clip 1330 to heat producing device 1310 horizontal clamping feature 1332 may insure a long term stability of the heat sink assembly 1300. There are four load points, owing to each of the first clip vertical clamping feature 1332, in the heat sink assembly 1300. The four load points per heat sink assembly 1300 may insure an added stability of the heat sink assembly 1300.

A second clip 1330 to heat sink 1328 lock feature 1333 may provide a horizontal locking between the second clip 1330 and the heat sink 1328. The second clip 1330 to heat sink 1328 lock feature 1333 may aid in stabilizing the heat sink 1328 during shock and vibration loads. A second clip 1330 to first clip 1320 vertical lock feature 1334 may provide a vertical locking between the first clip 1320 and the second clip 1330. A second clip 1330 to first clip 1320 horizontal lock feature 1335 may provide a horizontal locking between the first clip 1320 and the second clip 1330.

A heat sink 1328 may help cool the heat producing device 1310. A heat sink 1328 to second clip 1330 horizontal lock feature 1328A may provide a horizontal locking between the heat sink 1328 and the second clip 1330. A thermal interface material 1324 may help a removal of heat from a heat producing device 1310. The heat producing device 1310 may require heat removal. The heat producing device 1310 may have a Ball Grid Array type interconnect for attaching the first clip 1320.

FIG. 13C shows a top plane view of the assembled heat sink assembly 1300 shown in FIG. 13B. The first clip 1320, the first clip 1320 to second clip 1330 horizontal lock feature 1326, the second clip 1330, and the heat sink 1328 may be seen in FIG. 13C. FIG. 13D illustrates a side profile view of the assembled heat sink assembly 1300 of FIG. 13B at the cross-section line AA thereby showing the heat producing device 1310, the first clip 1320, the second clip 1330, the inverted base 1338, and the heat sink 1328. A Detail 2C from FIG. 13D is illustrated more clearly in FIG. 13E, thereby illustrating the heat producing device 1310, the first clip 1320, the locking tab 1322, the heat sink 1328, the second clip vertical clamping feature 1331, the second clip 1330 to heat producing device 1310 horizontal clamping feature 1332.

FIG. 13F shows a Detail 3B of FIG. 13G where FIG. 13G illustrates another perspective view, featuring the first clip 1320, the first clip 1320 to second clip 1330 horizontal lock feature 1326, the heat sink 1328, and the second clip 1330, of the assembled heat sink assembly 1300 shown in FIG. 13B. FIG. 13F shows the first clip 1320 to second clip 1330 horizontal lock feature 1326, the heat sink 1328 to second clip 1330 horizontal lock feature 1328A, the second clip 1330 to heat sink 1328 lock feature 1333, and the second clip 1330 to first clip 1320 horizontal lock feature 1335.

FIG. 13H shows another perspective view of the assembled heat sink assembly 1300 featuring the heat producing device 1310, the first clip 1320, the first clip 1320 to second clip 1330 horizontal lock feature 1326, the heat sink 1328, and the second clip 1330. FIG. 13I shows a Detail 4B of FIG. 13H, thereby illustrating the first clip 1320 to second clip 1330 vertical lock feature 1324A, the first clip 1320 to second clip 1330 horizontal lock feature 1326, the second clip 1330 to first clip 1320 vertical lock feature 1334, and the second clip 1330 to first clip 1320 horizontal lock feature 1335.

FIG. 13J shows a side profile view of the first clip 1320 including the hoop 1321. A Detail 5D of FIG. 13J is shown in FIG. 13K illustrating the first clip 1320, the hoop 1321, the first clip ramp 1325, and the first clip 1320 to second clip 1330 vertical lock feature 1324A. FIG. 13L shows a perspective view of the second clip 1330, including the inverted base 1338. FIG. 13M shows a Detail 5F of FIG. 13L, thereby illustrating the second clip vertical clamping feature 1331, the second clip 1330 to heat producing device 1310 horizontal clamping feature 1332, the second clip 1330 to heat sink 1328 lock feature 1333, and the second clip 1330 to first clip 1320 vertical lock feature 1334. FIG. 13N shows a perspective view of the first clip 1320. FIG. 13P shows a Detail 5B of FIG. 13N, thereby illustrating the first clip 1320, the hoop 1321, the locking tab 1322, lock wedge 1323, and the first clip 1320 to second clip 1330 horizontal lock feature 1326.

FIG. 14 shows an exemplary plot of a component size versus a keep out area required for a first clip in excess of a component area in percent. The component size may be a size of the heat producing device 110, 610, 710, 810, 910, 1010, 1110, 1210, and 1310 as illustrated in figures discussed above. As may be seen in FIG. 14, which has been plotted for an illustrative range of sizes from 19 mm through 45 mm, the keep out area required for a first clip in excess of a component area may vary from about 75% for a 19 mm size through about 28% for a 45 mm size. The plot may also be calculated by a formula as follows: [(Area of the heat generating device 110+Area of the first clip 220)−Area of the heat generating device 110]/Area of the heat generating device 110. As would be appreciated by a person having ordinary skill in the art, the foregoing formula has illustratively used the heat generating device 110 and the first clip 220 but other embodiments of the heat generating device 110 and the first clip 220 may also be used in the formula.

In further embodiments of the first clip 220, the first clips 620, 720, 820, 920, 1020, 1120, 1320 may be termed as frame clips 620, 720, 820, 920, 1020, 1120, 1320. The frame clips 220, 620, 720, 820, 920, 1020, 1120, 1320 may be configured to be included in the heat sink assemblies 100, 600, 700, 800, 900, 1000, 1100, 1200, 1300 by a human body. The frame clips 220, 620, 720, 820, 920, 1020, 1120, 1320 may be configured to be attached in the heat sink assemblies 100, 600, 700, 800, 900, 1000, 1100, 1200, 1300 without using one or more tools. In further embodiments of the first clip 220, the first clips 620, 720, 820, 920, 1020, 1120, 1220, 1320 may be configured at least for one of a stretch and a flexure. In still further embodiments of the first clip 220, the first clips 620, 720, 820, 920, 1020, 1120, 1220, 1320 may be configured to be attached to the heat producing device 110, 610, 710, 810, 910, 1010, 1110, 1210, 1310 attached to a circuit substrate. A circuit substrate may be a PCB as known in the art. The first clips 220, 620, 720, 820, 920, 1020, 1120, 1220, 1320 may be configured for installing on a PCB after soldering the heat producing device 110, 610, 710, 810, 910, 1010, 1110, 1210, 1310, such as after a solder reflow.

In the frame clips 620, 720, 1020, 1120, and 1220, the hoop 621, 721, 1021, 1121, 1221 may include the shaft 626, 726, 1026, 1126, 1226 respectively. In the frame clip 820, the hoop 821 may include the notch 826, e.g., a concave notch. In the frame clip 920, the hoop 921 may include the pin 926. The pin 926 may be similar to a blunt cone.

In the frame clips 1120 and 1220, the hoop 1121 may have an arcuate shaft 1126 and the hoop 1221 may have an arcuate shaft 1226. In the frame clip 1320, the hoop 1321 may form an acute angle E with one of the second edge and the fourth edge of the frame clip 1320 as shown in FIG. 13J. The second edge and the fourth edge of the frame clip 1320 correspond to the second edge 260, and the fourth edge 240 shown in FIG. 1A as discussed earlier.

In further embodiments of the second clip 330, the second clips 630, 730, 830, 930, 1030, 1130, 1330 may be termed as spring clips 630, 730, 830, 930, 1030, 1130, 1330. The spring clips 630, 730, 830, 930, 1030, 1130, 1330 may have a first end, a second end, and at least a portion, wherein the at least the portion may be configured to attach the first end and the second end.

In the spring clip 630 shown in FIG. 6A, the spring clip 630 may have a first end 630D, a second end 630F, and at least a portion as the second clip 630 to heat sink 628 lock feature 633. The second clip 630 to heat sink 628 lock feature 633 may be configured to attach the first end 630D and the second end 630F.

In the spring clip 730 shown in FIG. 7A, the spring clip 730 may have a first end 730D, a second end 730F, and at least a portion as the second clip 730 to heat sink 728 lock feature 733. The second clip 730 to heat sink 728 lock feature 733 may be configured to attach the first end 730D and the second end 730F.

In the spring clips 830A, 830C shown in FIG. 8A, the first end may be spring clip 830A, the second end may be spring clip 830C, and the at least the portion may be the rod 830B. The rod 830B may be configured to attach the spring clip 830A and the spring clip 830C.

In the spring clip 930 shown in FIG. 9A, the spring clip 930 may have a first end 930D, a second end 930F, and at least a portion as the second clip 930 to heat sink 928 lock feature 933. The second clip 930 to heat sink 928 lock feature 933 may be configured to attach the first end 930D and the second end 930F. Further, at least one of the first end 930D and the second end 930F may include a hole such as the second clip 930 to first clip 920 horizontal lock feature 935. A purpose served by the hole may be to accommodate the pin 926.

In the spring clip 1030 shown in FIG. 10A, the spring clip 1030 may have a first end 1030D, a second end 1030F, and at least a portion as the second clip 1030 to heat sink 1028 lock feature 1033. The second clip 1030 to heat sink 1028 lock feature 1033 may be configured to attach the first end 1030D and the second end 1030F.

In the spring clip 1130 shown in FIG. 11A, the spring clip 1130 may have a first end 1130D, a second end 1130F, and at least a portion as the second clip 1130 to heat sink 1128 lock feature 1133. The second clip 1130 to heat sink 1128 lock feature 1133 may be configured to attach the first end 1130D and the second end 1130F.

In the spring clip 1230 shown in FIG. 12A, the spring clip 1230 may have a first end 1230D, a second end 1230F, and at least a portion as the second clip 1230 to heat sink 1228 lock feature 1233. The second clip 1230 to heat sink 1228 lock feature 1233 may be configured to attach the first end 1230D and the second end 1230F.

In the spring clip 1330 shown in FIG. 13A, the spring clip 1330 may have a first end 1330D, a second end 1330F, and at least a portion as the second clip 1330 to heat sink 1328 lock feature 1333. The second clip 1330 to heat sink 1328 lock feature 1333 may be configured to attach the first end 1330D and the second end 1330F.

The spring clips 330, 630, 730, 830A and 830C, 930, 1030, 1130, 1230 may be configured to be included in a heat sink assembly by a human body. The spring clips 330, 630, 730, 830A and 830C, 930, 1030, 1130, 1230 may be configured to be attached in the heat sink assembly without using a tool.

As used in this specification and appended claims, the singular forms “a,” “an,” and “the” include plural referents unless the specification clearly indicates otherwise. The term “plurality” includes two or more referents unless the specification clearly indicates otherwise. Further, unless described otherwise, all technical and scientific terms used herein have meanings commonly understood by a person having ordinary skill in the art to which the disclosure pertains.

As a person having ordinary skill in the art would appreciate, the elements or blocks of the methods described above could take place at the same time or in an order different from the described order.

It should be emphasized that the above-described embodiments are merely some possible examples of implementation, set forth for a clear understanding of the principles of the disclosure. Many variations and modifications may be made to the above-described embodiments of the invention without departing substantially from the principles of the invention. All such modifications and variations are intended to be included herein within the scope of this disclosure and the present invention and protected by the following claims.

What is claimed is:

1. An apparatus comprising:
a first clip configured to be urgingly attached to a heat producing device, the first clip having at least a first edge, a second edge, a third edge, and a fourth edge, wherein at least one of the first edge and the third edge has a locking tab in a direction of an area enclosed by the first clip and wherein at least one of the second edge and the fourth edge has a lock wedge configured to grip the heat producing device;
a heat sink configured to be attached to the first clip; and
a second clip configured to be attached to the first clip, the second clip being sized to accommodate a portion of the heat sink, and the second clip urging the heat sink towards the heat producing device.

2. The apparatus of claim 1, wherein the first clip has a hoop attached to at least one of the first edge and the third edge of the first clip.

3. The apparatus of claim 2, wherein the at least one of the first edge and the third edge has a cross-section, the cross-section increasing from a first point proximate to one of the second edge and the fourth edge to a second point proximate to the hoop.

4. The apparatus of claim 2, wherein the first clip is configured at least for one of a stretch and a flexure.

5. The apparatus of claim 2, wherein a portion of the second clip is configured to be restrained by an overhang in the hoop of at least one of the first edge and the third edge and an overhang space of at least one of the first edge and the third edge.

6. The apparatus of claim 5, wherein the overhang space has a height in a range of about 1.50 mm to 2.00 mm.

7. The apparatus of claim 1, wherein the second clip includes at least one load point configured to urge the heat sink towards the heat producing device.

8. The apparatus of claim 7, wherein the at least one load point includes a portion spaced apart from the heat sink.

9. The apparatus of claim 1, wherein the second clip includes a protrusion configured to removably engage with a hoop of the first clip.

10. The apparatus of claim 1, wherein a thermal interface material is disposed between the heat sink and the heat producing device.

11. The apparatus of claim 10, wherein the thermal interface material is one of a phase change material and a thermal interface tape.

12. The apparatus of claim 1, wherein the second clip has a thickness to obtain a predetermined stiffness.

13. The apparatus of claim 1, wherein the first clip is configured to be installed in a keep out region having an area ranging from approximately 23.0 mm×22.5 mm for a substantially 17 mm component to approximately 51.0 mm×50.5 mm for a substantially 45 mm component.

14. The apparatus of claim 13, wherein the keep out region further includes an area of about 1.0 mm×10.0 mm in a vicinity of a hoop on at least one of the first edge and the third edge.

15. A method comprising:
providing a first clip to be urgingly attached to a heat producing device, the first clip having at least a first edge, a second edge, a third edge, and a fourth edge;
configuring at least one of the first edge and the third edge to have a locking tab;
gripping the heat producing device with the locking tab;
configuring a heat sink to be attached to the first clip; and
configuring a second clip to be attached to the first clip, the second clip being sized to accommodate a portion of the heat sink, and the second clip urging the heat sink towards the heat producing device.

16. The method of claim 15, wherein the method further comprises installing the first clip on the heat producing device attached to a circuit substrate.

17. The method of claim 15, wherein the providing the first clip further comprises configuring the first clip at least for one of stretching and flexing.

18 The method of claim 15, wherein the providing the first clip further includes attaching a hoop to at least one of the first edge and the third edge of the first clip.

19. The method of claim 18, wherein the gripping the heat producing device further includes curving at least one of the first edge and the third edge in a direction of an area enclosed by the first clip.

20. The method of claim 18, wherein the providing the first clip further includes dimensioning a cross-section of the at least one of the first edge and the third edge such that the cross-section increases from a first point proximate to one of the second edge and the fourth edge to a second point proximate to the hoop.

21. The method of claim 18, wherein the attaching the hoop further includes restraining a portion of the second clip by an overhang in the hoop of at least one of the first edge and the third edge and an overhang space of at least one of the first edge and the third edge.

22. The method of claim 15 further comprising configuring a lock wedge to grip the heat producing device.

23. The method of claim 15, wherein the configuring the second clip further comprises including at least one load point configured to urge the heat sink towards the heat producing device.

24. The method of claim 15, wherein the configuring the second clip further includes configuring a protrusion to removably engage with a hoop of the first clip.

25. The method of claim 15 further comprising disposing a thermal interface material between the heat sink and the heat producing device.

26. The method of claim 15, wherein the configuring the second clip further includes selecting a thickness to obtain a predetermined stiffness.

27. An apparatus comprising:
a frame clip configured to be urgingly attached to a heat producing device, the frame clip having at least a first edge, a second edge, a third edge, and a fourth edge, wherein at least one of the first edge and the third edge has a locking tab in a direction of an area enclosed by the frame clip.

28. The apparatus of claim 27, wherein the frame clip is configured to be included in a heat sink assembly by a human body.

29. The apparatus of claim 27, wherein the frame clip has a hoop attached to at least one of the first edge and the third edge of the frame clip.

30. The apparatus of claim 29, wherein the hoop comprises a shaft.

31. The apparatus of claim 29, wherein the hoop comprises a notch.

32. The apparatus of claim 29, wherein the hoop comprises a pin.

33. The apparatus of claim 29, wherein the hoop comprises an arcuate shaft.

34. The apparatus of claim 29, wherein the hoop forms an acute angle with one of the second edge and the fourth edge of the frame clip.

35. The apparatus of claim 29, wherein the at least one of the first edge and the third edge has a cross-section, the cross-section increasing from a first point proximate to one of the second edge and the fourth edge to a second point proximate to the hoop.

36. The apparatus of claim 27, wherein at least one of the second edge and the fourth edge has a lock wedge configured to grip the heat producing device.

37. The apparatus of claim 27, wherein the frame clip is configured to be installed in a keep out region having an area ranging from approximately 23.0 mm×22.5 mm for a substantially 17 mm component to approximately 51.0 mm×50.5 mm for a substantially 45 mm component.

38. The apparatus of claim 37, wherein the keep out region further includes an area of about 1.0 mm×10.0 mm in a vicinity of a hoop on at least one of the first edge and the third edge.

39. The apparatus of claim 27, wherein the frame clip is configured at least for one of a stretch and a flexure.

40. The apparatus of claim 27, wherein the frame clip is configured to be attached to the heat producing device attached to a circuit substrate.

41. An apparatus comprising:
a spring clip having a first end, a second end, and at least a portion, wherein the at least the portion is configured to attach the first end and the second end.

42. The apparatus of claim 41, wherein the at least the portion is a rod.

43. The apparatus of claim 41, wherein at least one of the first end and the second end comprises a hole.

44. The apparatus of claim 41, wherein the spring clip is configured to be included in a heat sink assembly by a human body.
